(19) United States
(12) Patent Application Publication
(10) Pub. No.: US 2025/0029555 A1
(43) Pub. Date: Jan. 23, 2025

(54) ELECTRONIC DEVICE INCLUDING DISPLAY AND OPERATING METHOD THEREOF

(71) Applicant: SAMSUNG ELECTRONICS CO., LTD., Suwon-si (KR)

(72) Inventors: Hongsuk KIM, Suwon-si (KR); Byungkwon KANG, Suwon-si (KR); Hyunsoo KIM, Suwon-si (KR); Soonsang PARK, Suwon-si (KR); Chanhyung YOO, Suwon-si (KR); Kwangtai KIM, Suwon-si (KR); Dongchoon HWANG, Suwon-si (KR)

(73) Assignee: SAMSUNG ELECTRONICS CO., LTD., Suwon-si (KR)

(21) Appl. No.: 18/775,627

(22) Filed: Jul. 17, 2024

Related U.S. Application Data
(63) Continuation of application No. PCT/KR2024/010045, filed on Jul. 12, 2024.

(30) Foreign Application Priority Data
Jul. 21, 2023 (KR) 10-2023-0095107
Oct. 27, 2023 (KR) 10-2023-0145595

(51) Int. Cl. G09G 3/3225; G02B 27/01

(52) U.S. Cl. CPC G09G 3/3225; G02B 27/0172; G02B 2027/0178; G09G 2300/0426; G09G 2320/0247

(57) ABSTRACT

An electronic device may include: a display panel in which a plurality of pixels arranged in a matrix; a first main gate line extending in a first direction and configured to be electrically connectible to a first pixel among the plurality of pixels; a second main gate line extending in the first direction and configured to be electrically connectible to a second pixel among the plurality of pixels, the second pixel being adjacent to the first pixel along a second direction intersecting the first direction; a first main source line extending in the second direction and configured to be electrically connectible to the first pixel; and a second main source line extending in the second direction and configured to be electrically connectible to a third pixel among the plurality of pixels, the third pixel being adjacent to the first pixel along the first direction.

### CROSS-REFERENCE TO RELATED APPLICATION(S)

This application is a continuation application, claiming priority under § 365 (c), of an International application No. PCT/KR2024/010045, filed on Jul. 12, 2024, which is based on and claims the benefit of a Korean patent application number 10-2023-0095107, filed on Jul. 21, 2023, in the Korean Intellectual Property Office, and of a Korean patent application number 10-2023-0145595, filed on Oct. 27, 2023, in the Korean Intellectual Property Office, the disclosure of each of which is incorporated by reference herein in its entirety.

### BACKGROUND

### 1. Field

The disclosure relates to an electronic device including a display and an operating method thereof.

### 2. Description of Related Art

With development of electronic device technologies, various types of electronic devices, such as a personal digital assistant (PDA), an electronic notebook, a smartphone, a tablet personal computer (PC), and a wearable device, are widely used. By way of example, an electronic device may provide virtual reality (VR) functionality that allows a user to have a realistic experience in a computer-generated virtual world, augmented reality (AR) which adds virtual information (or objects) to the real world, or mixed reality (MR) generated by mixing virtual reality and augmented reality.

A wearable electronic device that is worn by a user, such as a head-mounted device, may require compact space utilization and a technology to provide light corresponding to a screen display of a display to the user's eye through a lens to utilize space.

The above-described information may be provided as a related art to help understanding of the disclosure. No claim or determination is made as to the applicability of any of the foregoing as prior art to the disclosure.

### SUMMARY

According to an aspect of the disclosure, an electronic device may include: a display panel in which a plurality of pixels arranged in a matrix; a first main gate line extending in a first direction and configured to be electrically connectible to a first pixel among the plurality of pixels; a second main gate line extending in the first direction and configured to be electrically connectible to a second pixel among the plurality of pixels, the second pixel being adjacent to the first pixel along a second direction intersecting the first direction; a first main source line extending in the second direction and configured to be electrically connectible to the first pixel; a second main source line extending in the second direction and configured to be electrically connectible to a third pixel among the plurality of pixels, the third pixel being adjacent to the first pixel along the first direction; a switching circuit connected to one of the first main gate line or the first main source line and configured to selectively connect the first main gate line to a first sub-pixel in the first pixel or a second sub-pixel in the second pixel, or selectively connect the first main source line to the first sub-pixel or a third sub-pixel in the third pixel; and a display driving circuit electrically connected to the display panel and configured to drive the display panel.

The electronic device further may include a first transistor array electrically connected to the first main gate line and the first main source line and configured to drive the first sub-pixel. The switching circuit is connected between the first main gate line or the first main source line, and the first transistor array.

A plurality of sub-pixels including the first sub-pixel may be arranged in the first direction or the second direction in the first pixel, and the switching circuit may include at least one switch corresponding to at least part of the plurality of sub-pixels.

The electronic device further may include a lens in front of the display panel. The first pixel may be located on an edge area of the display panel.

The display driving circuit may be configured to: control the switching circuit to connect the first main gate line and the first main source line to the first sub-pixel; drive the first sub-pixel based on first pixel data; control the switching circuit to connect the first main gate line to the second sub-pixel or connect the first main source line to the third sub-pixel; and drive the second sub-pixel or the third sub-pixel based on second pixel data different from the first pixel data.

A first plurality of sub-pixels including the first sub-pixel may be arranged in the second direction in the first pixel. A second plurality of sub-pixels including the second sub-pixel may be arranged in the second direction in the second pixel. The second sub-pixel may be adjacent to the first pixel along the second direction. The switching circuit may include a first switching circuit connected to the first main gate line, the first switching circuit being configured to selectively connect the first main gate line to the first sub-pixel or the second sub-pixel.

The first switching circuit may include a first switch configured to selectively connect a first sub-gate line or a third sub-gate line to the first main gate line. The first sub-gate line may connect the first main gate line to the first sub-pixel, and the third sub-gate line may connect the first main gate line to the second sub-pixel. The display driving circuit may be configured to control the first switch to connect the first main gate line to the first sub-pixel and then connect the first main gate line to the second sub-pixel.

A first plurality of sub-pixels including the first sub-pixel may be arranged in the first direction in the first pixel. A second plurality of sub-pixels including the third sub-pixel may be arranged in the first direction in the third pixel. The third sub-pixel may be adjacent to the first pixel along the first direction. The switching circuit may include a second switching circuit connected to the first main source line, the second switching circuit being configured to selectively connect the first main source line to the first sub-pixel or the third sub-pixel.

The second switching circuit may include a second switch configured to selectively connect a first sub-source line or a third sub-source line, to the first main source line. The first sub-source line may connect the first main source line to the first sub-pixel and the third sub-source line connects the first main source line to the third sub-pixel. The display driving circuit may be configured to control the second switch to connect the first main source line to the first sub-pixel and then connect the first main source line to the third sub-pixel.

A plurality of sub-pixels may be arranged in a matrix along the first direction and the second direction in the first pixel, the second pixel, and the third pixel. The second sub-pixel may be adjacent to the first pixel along the second direction. The third sub-pixel may be adjacent to the first pixel along the first direction. The switching circuit may include: a first switching circuit connected to the first main gate line, the first switching circuit being configured to selectively connect the first main gate line to the first sub-pixel or the second sub-pixel, and a second switching circuit connected to the first main source line, the second switching circuit being configured to selectively connect the first main source line to the first sub-pixel or the third sub-pixel.

The display driving circuit may be configured to: control the switching circuit to connect the first main gate line and the first main source line to the first sub-pixel; drive the first sub-pixel based on first pixel data; control the first switching circuit to connect the first main gate line to the second sub-pixel; drive the second sub-pixel based on second pixel data different from the first pixel data; control the second switching circuit to connect the first main source line to the third sub-pixel; and drive the third sub-pixel based on third pixel data different from the first pixel data and the second pixel data.

According to an aspect of the disclosure, a method of operating an electronic device, may include: obtaining at least one piece of pixel data corresponding to a first pixel of a display panel; controlling a switching circuit to connect a first main source line and a first main gate line configured to be electrically connectible to the first pixel, to a first sub-pixel in the first pixel; driving the first sub-pixel based on the at least one piece of pixel data; controlling the switching circuit to connect the first main gate line to a second sub-pixel in a second pixel adjacent to the first pixel in a second direction, or connect the first main source line to a third sub-pixel in a third pixel adjacent to the first pixel in a first direction intersecting the second direction; and driving the second sub-pixel or the third sub-pixel based on the at least one piece of pixel data.

The obtaining the at least one piece of pixel data may include obtaining first pixel data and second pixel data different from the first pixel data. The driving the first sub-pixel may include driving the first sub-pixel based on the first pixel data. The driving the second sub-pixel or the third sub-pixel may include driving the second sub-pixel or the third sub-pixel based on the second pixel data.

The controlling the switching circuit to connect the first main gate line to the second sub-pixel or connect the first main source line to the third sub-pixel may include controlling a first switching circuit to connect the first main gate line to the second sub-pixel. The first switching circuit may be configured to selectively connect the first main gate line to the first sub-pixel or the second sub-pixel.

The controlling the switching circuit to connect the first main gate line to the second sub-pixel or connect the first main source line to the third sub-pixel may include controlling a second switching circuit to connect the first main source line to the third sub-pixel. The second switching circuit may be configured to selectively connect the first main source line to the first sub-pixel or the third sub-pixel.

According to an aspect of the disclosure, an electronic device may include: a display panel in which a plurality of pixels are arranged in a matrix; a first main gate line extending in a first direction and configured to be electrically connectible to a first pixel and a third pixel located in the first direction of the first pixel among the plurality of pixels; a first main source line extending in a second direction intersecting the first direction and configured to be electrically connectible to the first pixel and a second pixel located in the second direction of the first pixel; a first switching circuit connected to the first main gate line and configured to selectively connect the first main gate line to a first sub-pixel in the first pixel or a second sub-pixel in the second pixel; a second switching circuit connected to the first main source line and configured to selectively connect the first main source line to the first sub-pixel or a third sub-pixel in the third pixel; and a display driving circuit electrically connected to the display panel and configured to drive the display panel. The display driving circuit may be configured to control the first switching circuit to sequentially connect the first main gate line to the first sub-pixel and the second sub-pixel, or control the second switching circuit to sequentially connect the first main source line to the first sub-pixel and the third sub-pixel.

The display driving circuit may be configured to: control the first switching circuit or the second switching circuit to connect the first main gate line and the first main source line to the first sub-pixel; drive the first sub-pixel based on first pixel data; and drive the second sub-pixel or the third sub-pixel based on second pixel data different from the first pixel data, based on a control operation of the first switching circuit or the second switching circuit.

A plurality of sub-pixels may be arranged in a matrix along the first direction and the second direction in the first pixel, the second pixel, and the third pixel. The first main gate line may be always connected to a first common pixel of the first pixel located between the first sub-pixel and the second sub-pixel, and selectively connected to the first sub-pixel or the second sub-pixel through the first switching circuit. The first main source line may be always connected to a second common pixel of the first pixel located between the first sub-pixel and the third sub-pixel, and selectively connected to the first sub-pixel or the third sub-pixel through the second switching circuit.

The first switching circuit may include a first switch configured to selectively connect a first sub-gate line or a third sub-gate line, to the first main gate line. The first sub-gate line may be connected to the first sub-pixel, the second common pixel, and the third sub-pixel. The third sub-gate line may extend parallel to the first sub-gate line and is connected to the second sub-pixel. The second switching circuit may include a second switch configured to selectively connect a first sub-source line or a third sub-source line, to the first main source line. The first sub-source line may be connected to the first sub-pixel, the first common pixel, and the second sub-pixel. The third sub-source line may extend parallel to the first sub-source line and is connected to the third sub-pixel.

The display driving circuit may be configured to: control the first switch and the second switch to connect the first main gate line to the first sub-gate line and the first main source line to the first sub-source line; control the first switch and the second switch to connect the first main gate line to the third sub-gate line and the first main source line to the first sub-source line; control the first switch and the second switch to connect the first main gate line to the third sub-gate line and the first main source line to the third sub-source line; and control the first switch and the second switch to connect the first main gate line to the first sub-gate line and the first main source line to the third sub-source line.

### BRIEF DESCRIPTION OF THE DRAWINGS

The above and other aspects, features, and advantages of the disclosure will be more clearly understood from the following detailed description, taken in conjunction with the accompanying drawings, in which:

FIG. 1 is a block diagram illustrating an electronic device in a network environment according to one or more embodiments of the disclosure;

FIG. 2A is a perspective diagram illustrating an internal configuration of a wearable electronic device 200 according to one or more embodiments of the disclosure;

FIG. 2B is a diagram illustrating a front surface and a rear surface of a wearable electronic device 300 according to one or more embodiments;

FIG. 2C is a diagram illustrating a front surface and a rear surface of a wearable electronic device 300 according to one or more embodiments;

FIG. 3 is an example diagram illustrating an eye tracking camera structure of an electronic device according to one or more embodiments;

FIG. 4 is a diagram illustrating a display module according to one or more embodiments of the disclosure;

FIG. 5 is a block diagram illustrating an electronic device according to one or more embodiments of the disclosure;

FIG. 6A is a diagram illustrating a display screen according to a combination of a display and a lens according to a comparative example of the disclosure;

FIG. 6B is a diagram illustrating pincushion distortion according to a comparative example of the disclosure;

FIG. 7A is a view illustrating an operation of a sub-pixel circuit of a display according to a comparative example of the disclosure;

FIG. 7B is a view illustrating an operation of a sub-pixel circuit of a display according to a comparative example of the disclosure;

FIG. 7C is a view illustrating an operation of a sub-pixel circuit of a display according to a comparative example of the disclosure;

FIG. 7D is a view illustrating an operation of a sub-pixel circuit of a display according to a comparative example of the disclosure;

FIG. 7E is a view illustrating an operation of a sub-pixel circuit of a display according to a comparative example of the disclosure;

FIG. 8 is a diagram illustrating a sub-pixel circuit of a display according to one or more embodiments of the disclosure;

FIG. 9 is a diagram illustrating a connection structure of a display panel according to one or more embodiments of the disclosure;

FIG. 10 is a diagram illustrating a first switching circuit according to one or more embodiments of the disclosure;

FIG. 11A is a control state diagram illustrating a low state of a first switching circuit according to one or more embodiments of the disclosure;

FIG. 11B is a control state diagram illustrating a high state of a first switching circuit according to one or more embodiments of the disclosure;

FIG. 11C is a diagram illustrating a driving state of a pixel according to a switching operation of a first switch according to one or more embodiments of the disclosure;

FIG. 12 is a diagram illustrating a second switching circuit according to one or more embodiments of the disclosure;

FIG. 13A is a control state diagram illustrating a low state of a second switching circuit according to one or more embodiments of the disclosure;

FIG. 13B is a control state diagram illustrating a high state of a second switching circuit according to one or more embodiments of the disclosure;

FIG. 13C is a diagram illustrating a driving state of a pixel according to a switching operation of a second switch according to one or more embodiments of the disclosure;

FIG. 14 is a diagram illustrating a driving state of a pixel according to a switching operation of a first switch and a second switch according to one or more embodiments of the disclosure;

FIG. 15 is a diagram illustrating a driving state of a pixel according to a switching operation of a first switch and a second switch according to one or more embodiments of the disclosure;

FIG. 16 is a flowchart illustrating an operating method of an electronic device according to one or more embodiments of the disclosure; and

FIG. 17 is a flowchart illustrating an operating method of an electronic device according to one or more embodiments of the disclosure.

### DETAILED DESCRIPTION

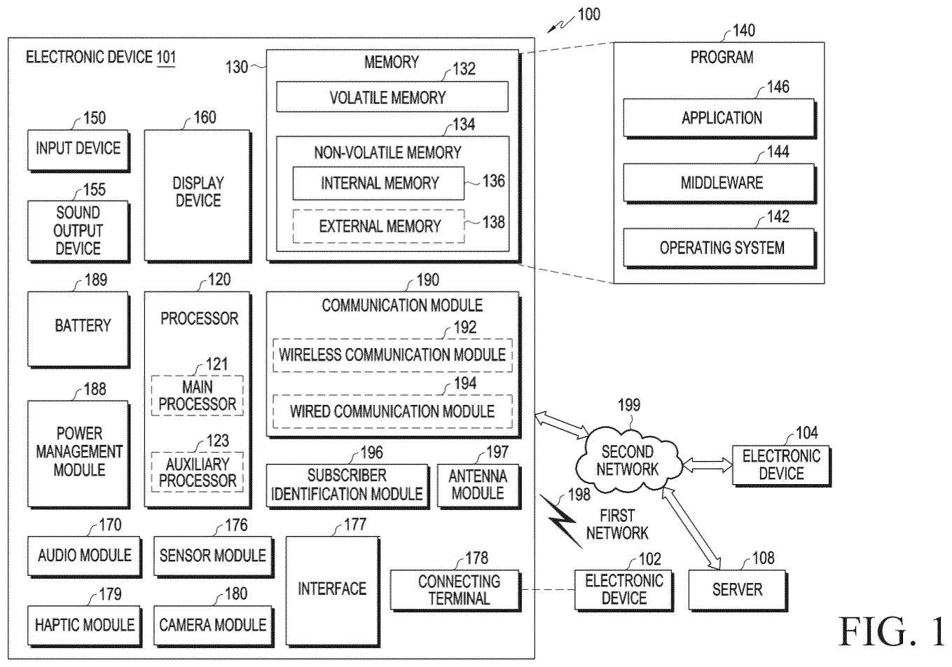

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least part of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

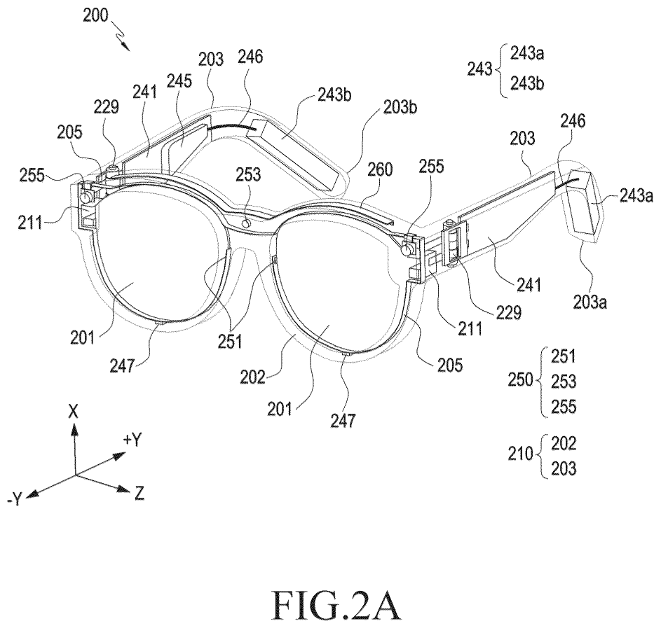

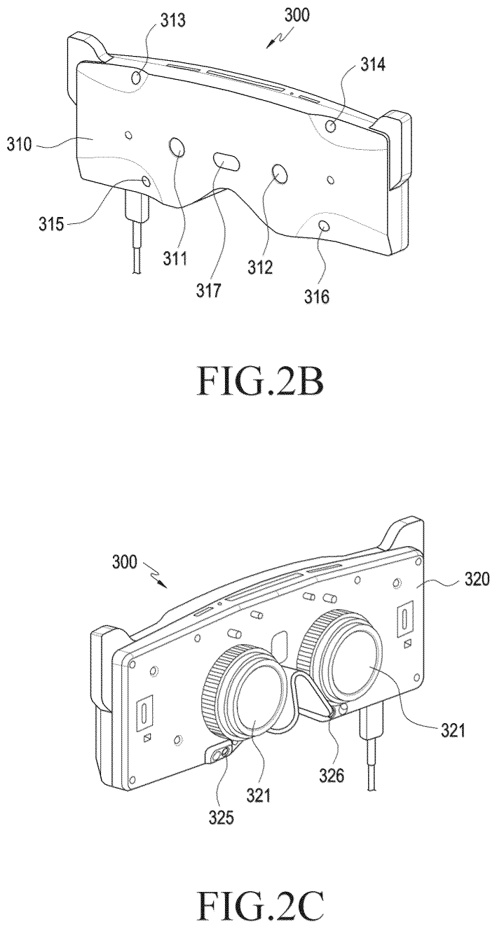

FIG. 2A is a perspective diagram illustrating an internal configuration of a wearable electronic device 200 according to one or more embodiments of the disclosure.

Referring to FIG. 2A, the wearable electronic device 200 may include a glasses-type electronic device and a user may recognize an object or environment while wearing the wearable electronic device 200. For example, the wearable electronic device 200 may include a head mounting device (HMD) or smart glasses which may directly provide an image in front of the user's eye. The configuration of the wearable electronic device 200 of FIG. 2A may be entirely or partially identical to that of the electronic device 101 of FIG. 1.

According to one or more embodiments, the wearable electronic device 200 may include a housing 210 configuring an exterior of the wearable electronic device 200. The housing 210 may provide a space in which components of the wearable electronic device 200 may be arranged. For example, the housing 210 may include a lens frame 202 and at least one wearing member 203.

According to one or more embodiments, the wearable electronic device 200 may include at least one display member 201 capable of providing visual information to a user. For example, the display member 201 may include a module to which a lens or a window member, a display, a waveguide, and/or a touch circuit is mounted. According to one or more embodiments, the display member 201 may be configured to be transparent or translucent. According to one or more embodiments, the display member 201 may include glass formed by a translucent material or a window member of which light transmittance may be adjusted by adjusting a coloring density. According to one or more embodiments, a pair of display members 201 may be provided and arranged to correspond to a right eye and a left eye of a user, respectively, while the wearable electronic device 200 is worn on the user's body.

According to one or more embodiment, the lens frame 202 may receive at least a portion of the display member 201. For example, the lens frame 202 may surround at least a portion of an edge of the display member 201. According to one or more embodiment, the lens frame 202 may locate at least one of the display member 201 to correspond to a user's eye. According to one or more embodiments, the lens frame 202 may include a rim of a general glasses structure. According to one or more embodiments, the lens frame 202 may include at least one closed curved line for surrounding the display member 201.

According to one or more embodiments, the wearing member 203 may extend from the lens frame 202. For example, the wearing member 203 may extend from an end part of the lens frame 202 and may be supported by or located on the user's body (e.g., the ear) together with the lens frame 202. According to one or more embodiments, the wearing member 203 may be rotatably coupled to the lens frame 202 through a hinge structure 229. According to one or more embodiments, the wearing member 203 may include an inner lateral surface configured to face a user's body and an outer lateral surface opposite to the inner lateral surface.

According to one or more embodiments, the wearable electronic device 200 may include a hinge structure 229 configured to allow the wearing member 203 to be foldable with respect to the lens frame 202. The hinge structure 229 may be disposed between the lens frame 202 and the wearing member 203. In a state of not wearing the wearable electronic device 200, the user may carry or store the wearable electronic device by folding the wearing member 203 so that a portion thereof partially overlaps the lens frame 202.

The wearable electronic device 200 may include components (e.g., at least one printed circuit board 241 (e.g., a printed circuit board (PCB), a printed board assembly (PBA), a flexible PCB (FPCB, or a rigid-flexible PCB (RFPCB)) received in the housing 210, at least one battery 243, at least one speaker module 245, at least one power transfer structure 246, and a camera module 250.

According to one or more embodiments, the wearable electronic device 200 may acquire and/or recognize a visual image related to an object or environment in a direction the user views or the wearable electronic device 200 is directed (e.g., the −Y direction) by using the camera module 250 (e.g., the camera 180 in FIG. 1) and may be provided with information on the object or environment from an external electronic device (e.g., the electronic device 102 or 104 or the server 108 in FIG. 1) through a network (e.g., the first network 198 or the second network 199 in FIG. 1). In one or more embodiments, the wearable electronic device 200 may provide the provided information on the object or environment to the user in an audio or visual form. The wearable electronic device 200 may provide the provided information on the object or environment to the user in a visual form by using a display module (e.g., the display 160 in FIG. 1) through the display member 201. For example, as the wearable electronic device 200 realizes the information on the object or environment in a visual form to be combined with a real image of user's surrounding, the wearable electronic device 200 may implement the augmented reality.

According to one or more embodiments, the display member 201 may include a first surface facing a direction (e.g., the −Y direction) in which light is incident and a second surface facing a direction (e.g., the +Y direction) opposite to the first surface. In a state in which the user wears the wearable electronic device 200, light incident through the first surface F1 or at least a portion of an image may pass through the second surface F2 of the display member 201 disposed to face the right eye and/or the left eye of the user to be incident to the right eye and/or the left eye of the user.

According to one or more embodiments, the lens frame 202 may include two or more frames. For example, the lens frame 202 may include a first frame and a second frame. According to one or more embodiments, in case that the user wears the wearable electronic device 200, the first frame 202a may correspond to a frame of a portion facing the user's face and the second frame 202b may correspond to a portion of the lens frame 202 spaced apart in a direction (e.g., the −Y direction) of the user's gaze with respect to the first frame 202a.

According to one or more embodiments, a light output module 211 may provide an image and/or moving image to the user. For example, the light output module 211 may include a display panel capable of outputting an image and a lens corresponding to the user's eye and guiding the image to the display member 201. For example, the user may acquire an image output from the display panel of the light output module 211 through the lens of the light output module 211.

According to one or more embodiments, the light output module 211 may include a display panel configured to display various information. For example, the display panel may include at least one of a liquid crystal display (LCD), a digital mirror device (DMD), a liquid crystal on silicon (LCoS), an organic light-emitting diode (OLED), or a micro light emitting diode (micro-LED). According to one or more embodiments, in case that the display panel and/or the light output module 211 includes one of a LCD, a DMD, or a LCOS, the wearable electronic device 200 may include a light source for emitting light to a display area of the light output module 211 and/or the display member 201.

According to one or more embodiments, in case that the display panel and/or the light output module 211 includes one of an OLED or a micro-LED, the wearable electronic device 200 may provide a virtual image to the user without including a separate light source. According to one or more embodiments, in case that the display panel is implemented with an organic light emitting diode or micro-LED, a light source is unnecessary and thus the wearable electronic device 200 may become lighter in terms of weight.

According to one or more embodiments, the lens may perform a function of adjusting a focus so that a screen output to the display panel may be seen by the user's eye. For example, the lens may include a Fresnel lens, a pancake lens, or a multichannel lens.

According to one or more embodiments, a waveguide may perform a function of transferring light generated from the display panel to the user's eye. For example, the waveguide may be formed of glass, plastic, or a polymer, and may include a nanopattern, for example, a grating structure having a polygonal or curved surface shape formed on a surface inside or outside. According to one or more embodiments, light incident on one end of the waveguide may be propagated inside the waveguide by the nanopattern and provided to the user. In addition, the waveguide including a free-form type prism may provide incident light to the user through a reflection mirror. According to one or more embodiments, the waveguide may include at least one of a diffraction element (e.g., a diffractive element (DOE) and a holographic optical element (HOE)) or a reflection element (e.g., a reflective mirror). In one or more embodiments, the waveguide may guide light of the display panel emitted from a light source to the user's eye by using at least one diffractive or reflective element.

According to one or more embodiments, the diffractive element may include an input optical member/output optical member. By way of example, the input optical member may indicate an input grating area and the output optical member may indicate an output grating area. The input grating area may serve as an input terminal that diffracts (or reflects) light output from a light source (e.g., a micro-LED) to transmit the light to the transparent member (e.g., a first transparent member, and a second transparent member) of a screen display part. The output grating area may serve as an outlet that diffracts (or reflects) the light transferred to the display member 201 of the waveguide to the user's eyes.

According to one or more embodiments, the reflection element may include a total internal reflection (TIR) optical element or a total internal reflection waveguide for total internal reflection. For example, the total internal reflection corresponds to a method of guiding light and may indicate creating an incidence angle so that light (e.g., a virtual image) input through the input grating area is 100% reflected from one surface (e.g., a predetermined surface) of the waveguide, and is 100% transferred to the output grating area.

In one or more embodiments, the light output from the display panel may have a light path guided to the waveguide through the input optical member. The light traveling inside the waveguide may be guided to the user's eye through the output optical member. The screen display part may be determined based on the light output to the eye.

According to one or more embodiments, at least a portion of the light output module 211 may be disposed in the housing 210. For example, the light output module 211 may be disposed in the wearing member 203 or the lens frame 202 to correspond to the user's right and left eyes, respectively. According to one or more embodiments, the light output module 211 may be connected to the display member 201 and may provide an image to the user through the display member 201.

According to one or more embodiments, the printed circuit board 241 may include components for driving the wearable electronic device 200. For example, the printed circuit board 241 may include at least one integrated circuit chip and at least one of the processor 120, the memory 130, the power management module 188, or the communication module 190 of FIG. 1 may be provided on the integrated chip. According to one or more embodiments, the printed circuit board 241 may be disposed in the wearing member 203 of the housing 210. According to one or more embodiments, the printed circuit board 241 may be electrically connected to the battery 243 through the power transfer structure 246. According to one or more embodiments, the printed circuit board 241 may be connected to the flexible printed circuit board 205 and may transfer an electrical signal to electronic components (e.g., the light output module 211, the camera module 250, and a light-emitting part) of the electronic device through the flexible printed circuit board 205. According to one or more embodiments, the printed circuit board 241 may correspond to a printed circuit board including an interposer.

According to various embodiments, the flexible printed circuit board 205 may extend from the printed circuit board 241 to an inside of the lens frame 202 via the hinge structure 229 and may be disposed on at least a portion of a circumference of the display member 201 inside the lens frame 202.

According to one or more embodiments, the battery 243 (e.g., the battery 189 in FIG. 1) may be electrically connected to components (e.g., the light output module 211, the printed circuit board 241, the speaker module 245, the microphone module 247, and the camera module 250) of the wearable electronic device 200 and may provide power to the components of the wearable electronic device 200.

According to one or more embodiments, at least a portion of the battery 243 may be disposed in the wearing member 203. According to one or more embodiments, the battery 243 may be disposed at an end part 203a or 203b of the wearing member 203. For example, the battery 243 may include a first battery 243a disposed at a first end part 203a and a second battery 243b disposed at a second end part 203b of the wearing member 203.

According to various embodiments, the speaker module 245 (e.g., the audio module 170 or the sound output module 155 in FIG. 1) may convert an electrical signal into a sound. At least a portion of the speaker module 245 may be disposed in the wearing member 203 of the housing 210. According to one or more embodiments, the speaker module 245 may be disposed in the wearing member 203 to correspond to the user's ear. For example, the speaker module 245 may be disposed between the printed circuit board 241 and the battery 243.

According to one or more embodiments, the power transfer structure 246 may transfer power of the battery 243 to an electronic component (e.g., the light output module 211) of the wearable electronic device 200. For example, the power transfer structure 246 may be electrically connected to the battery 243 and/or the printed circuit board 241 and the printed circuit board 241 may transfer power received through the power transfer structure 246 to the light output module 211. According to one or more embodiments, the power transfer structure 246 may be connected to the printed circuit board 241 via the speaker module 245. For example, when viewing the wearable electronic device 200 from the lateral surface (e.g., the Z-axis direction), the power transfer structure 246 may at least partially overlap the speaker module 245.

According to one or more embodiments, the power transfer structure 246 may include a configuration capable of transferring power. For example, the power transfer structure 246 may include a flexible printed circuit board or a wire. For example, the wire may include a plurality of cables. In various embodiments, a form of the power transfer structure 246 may be variously changed in consideration of the number and/or type of cables or the like.

According to one or more embodiments, the microphone module 247 (e.g., the input module 150 and/or the audio module 170 in FIG. 1) may convert a sound into an electrical signal. According to one or more embodiments, the microphone module 247 may be disposed on at least a portion of the lens frame 202. For example, at least one microphone module 247 may be disposed on a lower end (e.g., a direction facing the −X axis) and/or an upper end (e.g., a direction facing the X axis) of the wearable electronic device 200. According to one or more embodiments, the wearable electronic device 200 may recognize a user's voice more clearly by using voice information (e.g., a sound) acquired by at least one microphone module 247. For example, the wearable electronic device 200 may distinguish voice information and peripheral noise based on the acquired voice information and/or additional information (e.g., a low-frequency vibration of the user's skin and bones). For example, the wearable electronic device 200 may clearly recognize the user's voice and perform a function (e.g., noise canceling) for reducing peripheral noise.

According to one or more embodiments, the camera module 250 may capture a still image and/or video. The camera module 250 may include at least one of a lens, at least one image sensor, an image signal processor, or a flash. According to one or more embodiments, the camera module 250 may be disposed within the lens frame 202 and around the display member 201.

According to one or more embodiments, the camera module 250 may include a light-emitting part attachable to various locations. In one or more embodiments, the light-emitting part may be used as an auxiliary element to facilitate detection of the user's gaze through a first camera module 251. In one or more embodiments, the light-emitting part may be attached around the hinge structure 229 for connecting the lens frame 202 and the wearing member 203 or adjacent to a second camera module 253 disposed between lens frames 202 so as to be used as an element of supplementing surrounding brightness during photographing. Particularly, the light-emitting part may be effective when it is difficult to detect a subject in a dark environment.

According to one or more embodiments, the camera module 250 may include at least one first camera module 251. According to one or more embodiments, the first camera module 251 may capture the user's eye (e.g., a pupil) or a trajectory of a gaze. For example, the first camera module 251 may capture a reflection pattern of light emitted by the light-emitting part to the user's eye. For example, the light-emitting part may emit light in an infrared band for tracking a trajectory of a gaze by using the first camera module 251. For example, the light-emitting part may include an IR LED. According to one or more embodiments, a processor (e.g., the processor 120 in FIG. 1) may adjust a location of a virtual image so that the virtual image projected to the display member 201 corresponds to a direction in which the user's eye gazes. According to one or more embodiments, the first camera module 251 may include a global shutter (GS) type camera and a trajectory of the user's eyes or gaze by using may be tracked by using a plurality of first camera modules 251 of the same standard and performance.

According to various embodiments, the first camera module 251 may periodically or aperiodically transmit information (e.g., trajectory information) on tracking of a trajectory of the user's eye or gaze to the processor (e.g., the processor 120 in FIG. 1). According to one or more embodiments, when detecting that the user's gaze is changed (e.g., moving more than a reference value in a state in which the head does not move) based on the trajectory information, the first camera module 251 may transmit the trajectory information to the processor.

According to various embodiments, the camera module 250 may include a second camera module 253. According to one or more embodiments, the second camera module 253 may capture an image of the outside. According to one or more embodiments, the second camera module 253 may include a global shutter or rolling shutter (RS) type camera. According to one or more embodiments, the second camera module 253 may capture an image of the outside through a second optical hole formed through the second frame. For example, the second camera module 253 may include a high-resolution color camera and correspond to a high resolution (HP) or photo video (PV) camera. In addition, the second camera module 253 may provide an auto focus (AF) and image stabilization function (optical image stabilizer (OIS)). The second camera module 253 according to one or more embodiments disclosed herein may include one camera or a plurality of cameras.

According to one or more embodiments, the wearable electronic device 200 may include a flash located adjacent to the second camera module 253. For example, the flash may provide light for increasing brightness (e.g., illuminance) of a periphery of the wearable electronic device 200 when the second camera module 253 acquires an external image and may reduce image acquisition difficulties due to dark environments, incorporation of various light sources, and/or reflections of light.

According to one or more embodiments, the camera module 250 may include at least one third camera module 255. According to one or more embodiments, the third camera module 255 may capture an operation of the user or recognize a space through the first optical hole formed through the lens frame 202. For example, the third camera module 255 may detect a user's hand and capture a user's gesture (e.g., a hand motion). For example, the third camera module 255 may track a movement of a user's head or recognize a surrounding space.

According to one or more embodiments, the third camera module 255 and/or the first optical hole 221 may be disposed at opposite lateral ends of the lens frame 202 (e.g., the second frame 202b), for example, at opposite ends of the lens frame 202 (e.g., the second frame 202b) in the X direction, respectively. According to one or more embodiments, the third camera module 255 may include a global shutter type camera. For example, the third camera module 255 may correspond to a camera for supporting 3 degrees of freedom (3DoF) or 6DoF and may provide 360-degree space (e.g., omnidirectional) location recognition, and/or movement recognition.

According to one or more embodiments, the third camera module 255 may perform a moving path tracking function (simultaneous localization and mapping (SLAM)) and a user movement recognition function by using a plurality of global shutter (GS) type cameras having the same specifications and performance as stereo cameras. According to one or more embodiments, the third camera module 255 may include an infrared (IR) camera (e.g., a time of flight (TOF) camera or structured light camera). For example, the IR camera may operate as at least a portion of a sensor module (e.g., the sensor module 176 in FIG. 1) for detecting a distance to an object.

According to one or more embodiments, at least one of the first camera module 251 or the third camera module 255 may be replaced with a sensor module (e.g., the sensor module 176 in FIG. 1) (e.g., a Lidar sensor). For example, the sensor module may include at least one of a vertical cavity surface emitting laser, an infrared sensor, and/or a photodiode. For example, the photodiode may include a positive intrinsic negative (PIN) photodiode or an avalanche photo diode (APD). The photodiode may be referred to as a photo detector or a photo sensor.

According to one or more embodiments, at least one of the first camera module 251, the second camera module 253, or the third camera module 255 may include a plurality of camera modules. For example, the second camera module 253 may include a plurality of lenses (e.g., wide-angle and telephoto lenses) and image sensors and may be disposed on a surface (e.g., a surface facing the −Y axis) of the wearable electronic device 200. For example, the wearable electronic device 200 may include a plurality of camera modules having different properties (e.g., an angle of view) or functions and control to change angles of view of camera modules based on a user's selection and/or trajectory information. For example, at least one of the a plurality of camera modules may correspond to a wide-angle camera and at least another one may correspond to a telephoto camera.

According to various embodiments, the processor (e.g., the processor 120 in FIG. 1) may determine movement of the wearable electronic device 200 and/or movement of the user based on information of the wearable electronic device 200 acquired by using at least one of a gesture sensor, a gyro sensor, or an acceleration sensor of the sensor module (e.g., the sensor module 176 in FIG. 1) and an operation (e.g., approach of the user to the wearable device 200) of the user acquired by using the second camera module 253 and the third camera module 255. According to one or more embodiments, in addition to the sensors described above, the wearable electronic device 200 may include a magnetic (geomagnetic) sensor that may measure a direction using a magnetic field and magnetic line of force, and/or a Hall sensor that may acquires movement information (e.g., a movement direction or movement distance) using a strength of a magnetic field. For example, the processor may determine movement of the wearable electronic device 200 and/or movement of the user based on information acquired from a magnetic (geomagnetic) sensor and/or a Hall sensor.

According to various embodiments, the wearable electronic device 200 may perform an input function (e.g., a touch and/or pressure detection function) which allows interaction with the user. For example, a component (e.g., a touch sensor and/or pressure sensor) configured to perform a touch and/or pressure detection function may be disposed on at least a portion of the wearing member 203. The wearable electronic device 200 may control a virtual image output through the display member 201 based on information acquired through the components. For example, a sensor related to a touch and/or pressure detection function may be configured in various types, such as a resistive type, a capacitive type, an electro-magnetic type (EM), or an optical type. According to one or more embodiments, the component configured to perform the touch and/or pressure detection function may be entirely or partially identical to the input module 150 in FIG. 1.

According to one or more embodiments, the wearable electronic device 200 may include a reinforcement member 260 disposed in an internal space of the lens frame 202 and formed to have a rigidity higher than that of the lens frame 202.

According to one or more embodiments, the wearable electronic device 200 may include a lens structure. The lens structure may refract at least a portion of light. For example, the lens structure may correspond to a prescription lens having pre-designated refractive power. According to one or more embodiments, the lens structure may be disposed in a rear side (e.g., the +Y direction) of a second window member of the display member 201. For example, the lens structure may be disposed between the display member 201 and the user's eye. For example, the lens structure may face one surface of the display member 201.

According to one or more embodiments, the housing 210 may include a hinge cover for covering a portion of the hinge structure 229. Another portion of the hinge structure 229 may be received between or covered by an inner case and an outer case.

According to one or more embodiments, the wearing member 203 may include an inner case and an outer case. The inner case may correspond to, for example, a case configured to face the user's body or come into direct contact with the user's body and may be manufactured by a material with low thermal conductivity such as a resin. According to one or more embodiments, the inner case may include an inner lateral surface facing the user's body. The outer case may include, for example, a material (e.g., a metallic material) capable of at least partially transferring heat and may be coupled to face the inner case. According to one or more embodiments, the outer case may include an outer lateral surface opposite to the inner lateral surface. In one or more embodiments, at least one of the printed circuit board 241 or the speaker module 245 may be received in a space separated from the battery 243 within the wearing member 203. In the embodiment disclosed herein, the inner case may include a first case including the printed circuit board 241 or the speaker module 245 and a second case for receiving the battery 243, and the outer case may include a third case coupled to face the first case and a fourth case coupled to face the second case. For example, the first case and the third case area may be coupled (hereinafter, a “first case part”) to receive the printed circuit board 241 and/or the speaker module 245, and the second case and the fourth case may be coupled (hereinafter, a “second case part”) to receive the battery 243.

According to various embodiments, the first case part may be rotatably coupled to the lens frame 202 through the hinge structure 229, and the second case part may be connected or mounted to an end portion of the first case part through the connection member. In some embodiments, a portion of the connection member, which comes in contact with the user's body, may be manufactured of a material having a low heat conductivity, for example, an elastic material such as silicone or polyurethane, and a portion not in contact with the user's body may be manufacture of a material (e.g., a metallic material) having a high conductivity. For example, in case that heat is generated from the printed circuit board 241 or the battery 243, the connection member may block the heat from being transferred to the portion coming in contact with the user's body and disperse or dissipate the heat through the portion not in contact with the user's body. According to one or more embodiments, the portion of the connection member which is configured to come in contact with the user's body, may be interpreted as a portion of the inner case, and the portion of the connection member which is not in contact with the user's body may be interpreted as a portion of the outer case. According to one or more embodiments, the first case and the second case may be integrally formed without the connection member, and the third case and the fourth case may be integrally formed without the connection member. According to various embodiments, other components (e.g., the antenna module 197 in FIG. 1) may be further included in addition to the aforementioned components, and information on the object or environment may be provided from an external electronic device (e.g., the external electronic device 102 of 104 or the server 108 in FIG. 1) through the network (e.g., the first network 198 or the second network 199 in FIG. 1) by using the communication module 190.

Only the wearable device 200 is shown and described in FIG. 2A, but embodiments of the disclosure are not limited thereto, and a portion of the configuration of the wearable device 200 shown in FIG. 2A may be included in an electronic device, such as a smart phone or a tablet PC.

FIGS. 2B and 2C are diagrams illustrating a front surface and a rear surface of a wearable electronic device 300 according to one or more embodiments.

Referring to FIGS. 2B and 2C, in one or more embodiments, a depth sensor 317 and/or camera modules 311, 312, 313, 314, 315, and 316 for obtaining information related to a peripheral environment of the wearable electronic device 300 may be arranged on a first surface 310 of a housing.

In one or more embodiments, the camera modules 311 and 312 may acquire an image related to a peripheral environment of the wearable electronic device 300.

In one or more embodiments, the camera modules 313, 314, 315, and 316 may acquire an image in a state in which the wearable electronic device is worn by the user. The camera modules 313, 314, 315, and 316 may be used for hand detection and tracking and recognition of a user gesture (e.g., a hand gesture). The camera modules 313, 314, 315, and 316 may be used for head tracking of 3DoF and 6DoF, location (space, environment) recognition, and/or movement recognition. In one or more embodiments, the camera modules 311 and 312 may be used for hand detection and tracking and user gesture recognition.

In one or more embodiments, the depth sensor 317 may be configured to transmit a signal and receive a signal reflected from a subject and may be used to identify a distance to an object, such as time of flight (TOF). For example, the depth sensor 317 may measure the distance to the subject by using near-infrared rays, ultrasound, or laser. In one or more embodiments, the depth sensor 317 may include a transmission part for emitting a signal and a reception part for measuring a signal to measure the time of flight (TOF) of the signal.

According to one or more embodiments, a face recognition camera module 325 or 326 and/or a display 321 (and/or a lens) may be arranged on a second surface 320 of the housing.

In one or more embodiments, the face recognition camera module 325 or 326 adjacent to the display may be used to recognize the user's face or may recognize and/or track both eyes of the user. In one or more embodiments, the face recognition camera module 325 or 326 may detect or track a face expression of the user.

In one or more embodiments, the display 321 (and/or the lens) may be disposed on the second surface 320 of the wearable electronic device 300. In one or more embodiments, the wearable electronic device 300 may not include the camera modules 315 and 316 among a plurality of camera modules 313, 314, 315, and 316. The wearable electronic device 300 may further include at least one of components shown in FIG. 2A.

In one or more embodiments, the display 321 may be understood to include a display module (e.g., the display module 160 in FIG. 1 or the display member 201 in FIG. 2A) for outputting a screen and a lens assembly for focusing the output screen onto the user's eyes. Note that in the structure of the display 321 in FIG. 2C, reference numbers are assigned to portions visible from the exterior of the wearable electronic device 300, and are indicated to the lens closest to the user's eyes.

As described above, the wearable electronic device 300 according to one or more embodiments may have a form factor to be mounted on the user's head. The wearable electronic device 300 may further include a strap and/or wearing member for securing same onto a user's body part. The wearable electronic device 101 may provide a user experience based on augmented reality, virtual reality, and/or mixed reality in a state of being mounted on the user head.

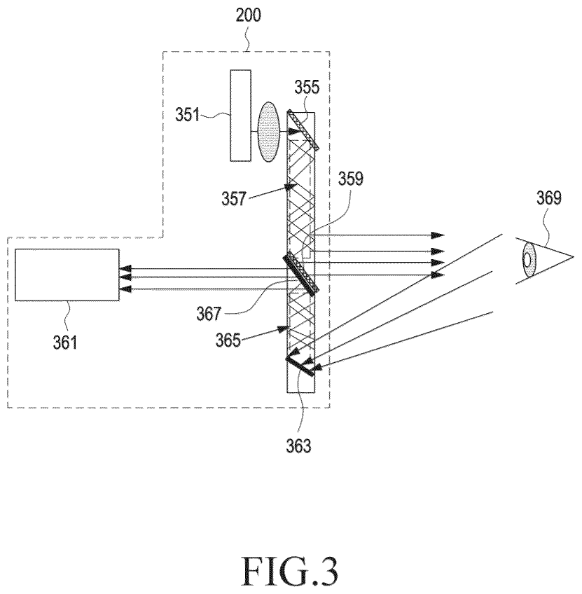

FIG. 3 is an example diagram illustrating an eye tracking camera structure of an electronic device 200 according to one or more embodiments.

Referring to FIG. 3, the electronic device 200 may include at least one of an eye tracking (ET) camera 361 (e.g., the at least one first camera module 251 in FIG. 2A), a display 351, an input optical member 355, a first waveguide 357, an output optical member 359, a first splitter 363, a second waveguide 365, or a second splitter 367.

In one or more embodiments, a pupil 369 of the user may be captured by the ET camera 361 through the first splitter 363 (e.g., an eye tracking splitter), the second waveguide 365, and the second splitter 367. In one or more embodiments, the ET camera 361 may detect the pupil 369 from the captured image and identify a movement of the detected pupil 369 so as to track the user's gaze.

In one or more embodiments, an image output through the display 351 may be reflected by the input optical member 355 and the first waveguide 357 and displayed through the output optical member 359. In one or more embodiments, the electronic device 200 may track (e.g., identify) the user's gaze (e.g., a direction of the user's gaze) by identifying a movement of the pupil 369 of the user while outputting an image through the display 351.

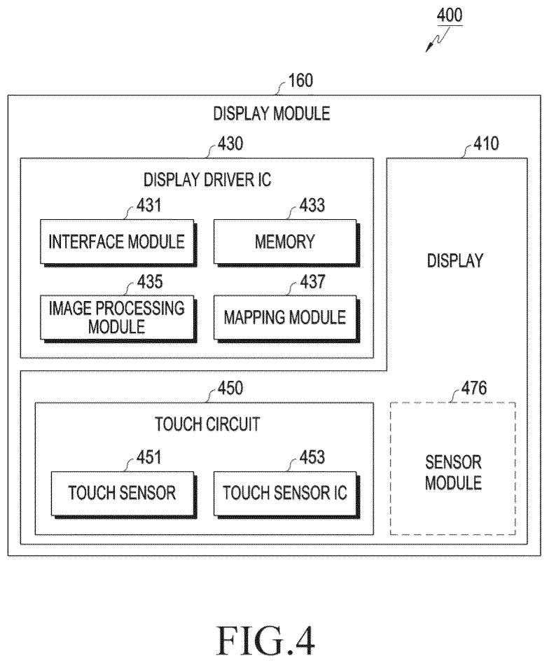

FIG. 4 is a diagram 400 illustrating the display device 160 according to an embodiment.

Referring to FIG. 4, the display device 160 may include a display 410 and a display driver integrated circuit (DDI) 430 to control the display 410. The DDI 430 may include an interface module 431, memory 433 (e.g., buffer memory), an image processing module 435, or a mapping module 437. The DDI 430 may receive image information that contains image data or an image control signal corresponding to a command to control the image data from another component of the electronic device 101 via the interface module 431. For example, according to an embodiment, the image information may be received from the processor 420 (e.g., the main processor 121 (e.g., an application processor)) or the auxiliary processor 123 (e.g., a graphics processing unit) operated independently from the function of the main processor 121. The DDI 430 may communicate, for example, with touch circuitry 450 or the sensor module 476 (e.g., sensor module of FIG. 1) via the interface module 431. The DDI 430 may also store at least part of the received image information in the memory 433, for example, on a frame by frame basis.

The image processing module 435 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 410.

The mapping module 437 may generate a voltage value or a current value corresponding to the image data pre-processed or post-processed by the image processing module 435. According to an embodiment, the generating of the voltage value or current value may be performed, for example, based at least in part on one or more attributes of the pixels (e.g., an array, such as an RGB stripe or a pentile structure, of the pixels, or the size of each subpixel). At least part of pixels of the display 410 may be driven, for example, based at least in part on the voltage value or the current value such that visual information (e.g., a text, an image, or an icon) corresponding to the image data may be displayed via the display 410.

According to an embodiment, the display device 160 may further include the touch circuitry 450. The touch circuitry 450 may include a touch sensor 451 and a touch sensor IC 453 to control the touch sensor 451. The touch sensor IC 453 may control the touch sensor 541 to sense a touch input or a hovering input with respect to a certain position on the display 410. To achieve this, for example, the touch sensor 451 may detect (e.g., measure) a change in a signal (e.g., a voltage, a quantity of light, a resistance, or a quantity of one or more electric charges) corresponding to the certain position on the display 410. The touch circuitry 450 may provide input information (e.g., a position, an area, a pressure, or a time) indicative of the touch input or the hovering input detected via the touch sensor 451 to the processor 420. According to an embodiment, at least part (e.g., the touch sensor IC 453) of the touch circuitry 450 may be formed as part of the display 410 or the DDI 430, or as part of another component (e.g., the auxiliary processor 123) disposed outside the display device 160.

According to an embodiment, the display device 160 may further include at least one sensor (e.g., a fingerprint sensor, an iris sensor, a pressure sensor, or an illuminance sensor) of the sensor module 476 or a control circuit for the at least one sensor. In such a case, the at least one sensor or the control circuit for the at least one sensor may be embedded in one portion of a component (e.g., the display 410, the DDI 430, or the touch circuitry 450)) of the display device 160. For example, when the sensor module 476 embedded in the display device 160 includes a biometric sensor (e.g., a fingerprint sensor), the biometric sensor may obtain biometric information (e.g., a fingerprint image) corresponding to a touch input received via a portion of the display 410. As another example, when the sensor module 476 embedded in the display device 160 includes a pressure sensor, the pressure sensor may obtain pressure information corresponding to a touch input received via a partial or whole area of the display 410. According to an embodiment, the touch sensor 451 or the sensor module 476 may be disposed between pixels in a pixel layer of the display 410, or over or under the pixel layer.

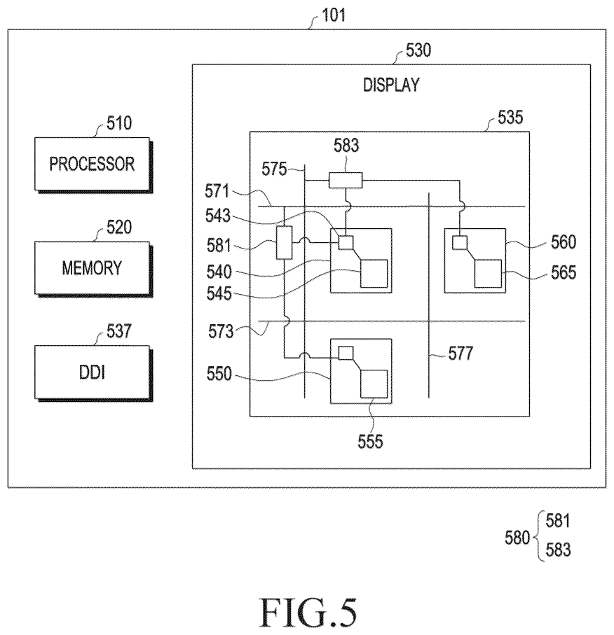

FIG. 5 is a block diagram illustrating an electronic device 101 according to one or more embodiments of the disclosure.

Referring to FIG. 5, the electronic device 101 (e.g., the electronic device 101 in FIG. 1, the wearable electronic device 200 in FIG. 2A, or the wearable electronic device 300 in FIG. 2B) may include a processor 510, memory 520, a display 530, and/or a display driving circuit (IC) 537 (e.g., DDI).

The processor 510 (e.g., the processor 120 in FIG. 1) according to one or more embodiments may execute an application or operation stored in the memory 520 (e.g., the memory 130 in FIG. 1). In one or more embodiments, the processor 510 may control at least one other component (e.g., a hardware or software component) included in the electronic device 101 or may perform various data processing or calculations.

The display 530 (e.g., the display module 160 in FIG. 1) according to one or more embodiments may include pixels (PXs) 540, 550, and 560 including various display elements, such as an organic light-emitting diode (OLED) arranged thereon. In the display 530 according to one or more embodiments, various wires for transferring an electrical signal to be applied to a display panel 535 (e.g., the display 410 in FIG. 4) may be located. Hereinafter, for convenience, the display 530 including an organic light-emitting diode as a display element will be described. However, without limitation thereto, it may be applied to various types of displays 530, such as a liquid crystal display, an electrophoretic display, and an inorganic EL display.

The display 530 according to one or more embodiments may Ide a display panel 535 in which a plurality of main gate lines 571 and 573 and a plurality of main source lines 575 and 577 are connected and a plurality of pixels 540, 550, and 560 are arranged in a matrix form. In a periphery of the display panel 535 according to one or more embodiments, there may be provided a gate driving circuit for driving the plurality of main gate lines 571 and 573, a light-emitting driving circuit for driving a plurality of light-emitting signal lines, a data driving circuit for supplying a data voltage through the plurality of main source lines 575 and 577, a timing controller for controlling the gate driving circuit and the data driving circuit, and a power management circuit (IC).

In one or more embodiments, the display panel 535 may display an image based on a scan signal transferred to the gate driving circuit through the plurality of main gate lines 571 and 573 and a data voltage transferred to the data driving circuit through the plurality of main source lines 575 and 577.

In one or more embodiments, the display panel 535 may include a plurality of pixels 540, 550, and 560 arranged in a matrix form, and each pixel 540, 550, or 560 may include different colored sub-pixels 545, 555, and 565, such as a white sub-pixel, a red sub-pixel, a green sub-pixel, and a blue sub-pixel.

In one or more embodiments, each pixel 540, 550, or 560 may be defined by each main gate line 571 or 573 and each main source line 575 or 577. In one or more embodiments, one pixel may be formed on an area in which the main source line 575 or 577 and the main gate line 571 and 573 intersect.

In one or more embodiments, the main source lines 575 and 577 may be branched into at least one sub-source line and connected to each other, the main gate lines 571 and 573 may be branched into at least one sub-gate line and connected to each other, and each sub-pixel 545, 555, or 565 may be formed on an area in which the sub-source line and the sub-gate line intersect.

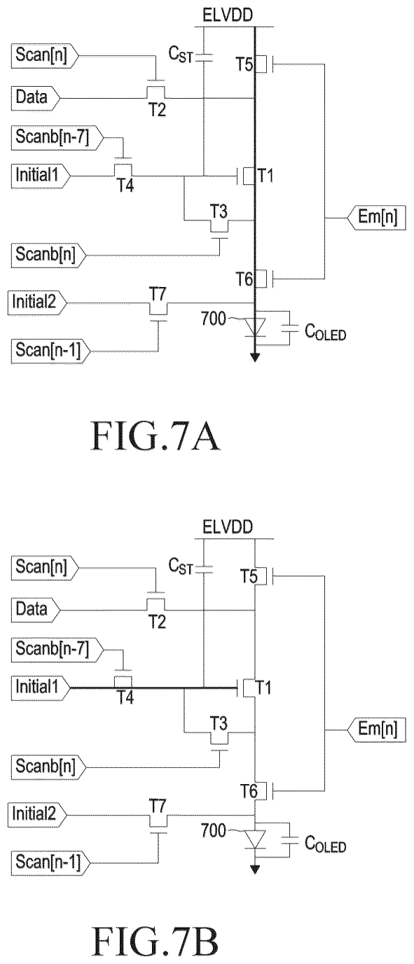

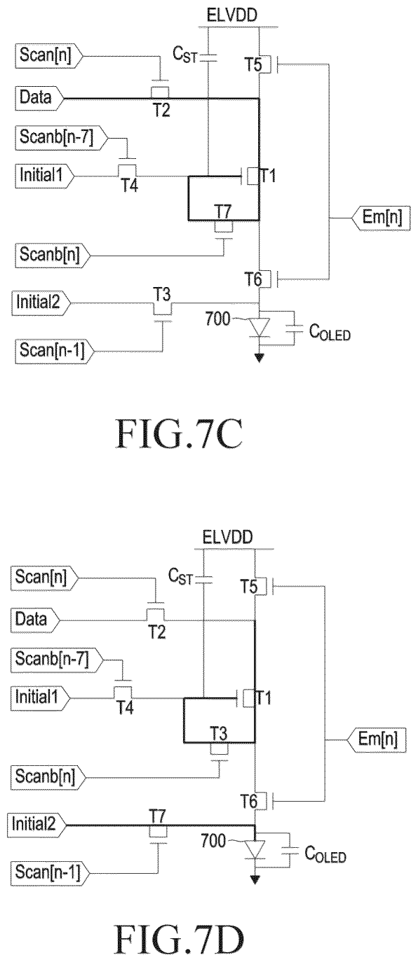

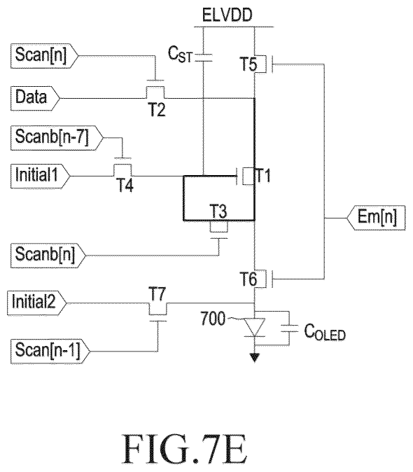

In one or more embodiments, the sub-pixel 545, 555, or 565 may include a plurality of thin film transistors (TFTs) 543 for driving the sub-pixel 545, 555, or 565, a light-emitting diode, such as an organic light-emitting diode, for charging a data voltage, and a storage capacitor electrically connected to the light-emitting diode and maintaining a voltage provided therein. In one or more embodiments, the sub-pixel 545, 555, or 565 may charge a data voltage (e.g., the data voltage (Data) in FIGS. 7A to 7E) to the storage capacitor during a writing period and repeat turning on and off according to an emission signal (EM). For example, the sub-pixel 545, 555, or 565 may repeat turning on and off within one frame period to emit light with a duty ratio of 50% or less and repeat turning on/off (On/Off).

In one or more embodiments, the display panel 535 may include a switching circuit 580 provided therein, which is connected to one of a first main gate line 571 or a first main source line 575 and configured to selectively connect the first main gate line 571 to a first sub-pixel 545 included in a first pixel 540 or a second sub-pixel 555 included in a second pixel 550, or selectively connect the first main source line 575 to the first sub-pixel 545 or a third sub-pixel 565 included in a third pixel 560.

In one or more embodiments, the display panel 535 may include a first switching circuit 581 provided therein to be connected to the first main gate line 571 and connected to the first sub-pixel 545 of the first pixel 540 and the second sub-pixel 555 of the second pixel 550 disposed adjacent to the first pixel 540 in a direction intersecting the first main gate line 571. In one or more embodiments, the first switching circuit 581 may be configured to selectively connect the first main gate line 571 to the first sub-pixel 545 or the second sub-pixel 555.

In one or more embodiments, the display panel 535 may include a second switching circuit 583 provided therein to be connected to the first main source line 575 and connected to the first sub-pixel 545 of the first pixel 540 and the third sub-pixel 565 of the third pixel 560 disposed adjacent to the first pixel 540 in a direction intersecting the first main source line 575. In one or more embodiments, the second switching circuit 583 may be configured to selectively connect the first main source line 575 to the first sub-pixel 545 or the third sub-pixel 565.

The display driving circuit 537 (e.g., the display driver IC 430 in FIG. 4) according to one or more embodiments may receive image information including image data and an image control signal from the processor 510.

In one or more embodiments, the display driving circuit 537 may store at least a portion of the received image information in the memory 520 or a buffer in a unit of frame, for example. In one or more embodiments, the display driving circuit 537 may drive at least part of pixels 540, 550, and 560 included in the display panel 535 at least partially based on a voltage value or a current value to display visual information (e.g., a text, an image, or an icon) corresponding to image data through the display 530.

In addition, the electronic device 101 according to one or more embodiments may further include other components included in the electronic device 101 shown in FIG. 1.

In one or more embodiments, the electronic device 101 may further include a communication circuit (e.g., the communication module 190 in FIG. 1) and transmit or receive data or a signal to or from an external electronic device (e.g., the external electronic device 102, 104, or 108 in FIG. 1). For example, the external electronic device 102, 104, or 108 may correspond to a case device which may store and charge the electronic device 101.

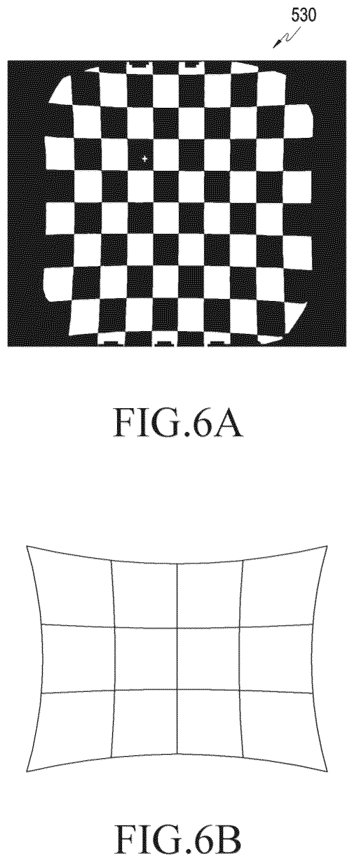

FIG. 6A is a diagram illustrating a display screen according to a combination of a display 530 and a lens according to a comparative example of the disclosure. FIG. 6B is a diagram illustrating pincushion distortion according to a comparative example of the disclosure.

Referring to FIGS. 6A and 6B, the electronic device 101 according to one or more embodiments may display an image by combining the display 530 and the lens. In this case, as shown in FIGS. 6A and 6B, pincushion distortion, where a periphery portion, that is, an edge of a display screen is stretched, may occur. In one or more embodiments, in case that a pancake lens having a thin thickness is used, the pincushion distortion may occur relatively large.

The electronic device 101 according to one or more embodiments may use an image in which the periphery portion is relatively reduced compared to the center portion to compensate for the pincushion distortion. However, in this case, a problem may occur in which the resolution of the peripheral portion of the display 530 is lowered compared to the central portion thereof having the same resolution.

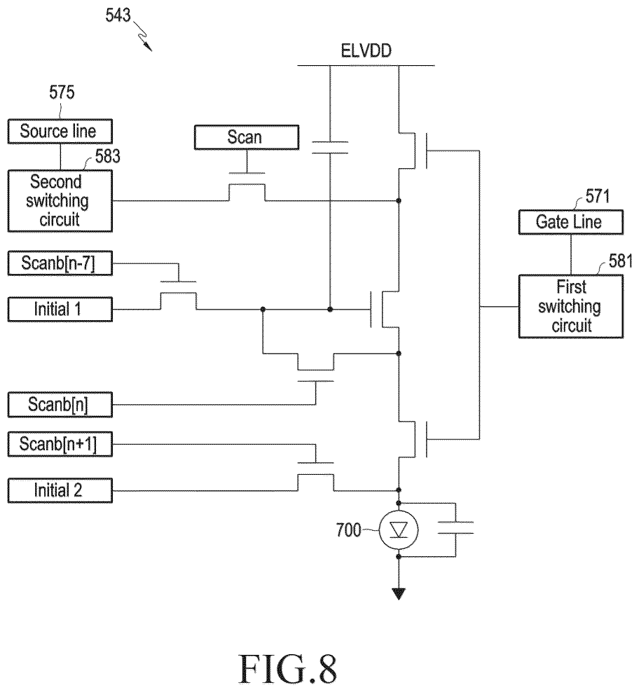

FIGS. 7A, 7B, 7C, 7D, and 7E are views illustrating an operation of a sub-pixel circuit of a display according to a comparative example of the disclosure. FIG. 8 is a diagram illustrating a sub-pixel circuit of a display according to one or more embodiments of the disclosure.

Referring to FIGS. 7A, 7B, 7C, 7D, 7E, and 8, a sub-pixel of the display (e.g., the display 530 in FIG. 5) according to one or more embodiments may include a plurality of switching transistors T1 to T7, a storage capacitor Cst, and a light-emitting device 700. Here, the description will be made assuming that the light emitting device 700 is an n-th sub-pixel that emits light by an n-th light emission signal Em(n). In this case, the light-emitting device 700 may include a self-luminous device that may generate light by itself, such as an organic light-emitting diode (OLED).

In one or more embodiments, in the sub-pixel, an N-type transistor among the plurality of transistors T1 to T7 may include an oxide transistor formed using a semiconducting oxide (e.g., a transistor having a channel formed from a semiconducting oxide such as indium, gallium, zinc oxide, or IGZO). In one or more embodiments, in the sub-pixel, a P-type transistor among the plurality of transistors T1 to T7 may include a silicon transistor formed from a semiconductor such as silicon (e.g., a transistor with a polysilicon channel formed using a low temperature process referred to as LTPS or low temperature polysilicon). The oxide transistor may have a relatively lower leakage current than the silicon transistor and thus in case that the transistor is realized using the oxide transistor, there is an effect of reducing image quality defects such as flicker by preventing current leakage from a gate electrode of the first switching transistor T1. In one or more embodiments, the P-type transistor may be selected from, for example, GaN, AlN, AlGaN, InGaN, InN, InAlGaN, AlInN, etc., and may be doped with a p-type dopant such as Mg, Zn, Ca, Sr, or Ba. In one or more embodiments, the N-type transistor may be selected from GaN, AlN, AlGaN, InGaN, InN, InAlGaN, AlInN, etc., and may be doped with an n-type dopant such as Si, Ge, or Sn.

In one or more embodiments, one end of the storage capacitor Cst may receive a high-potential driving voltage ELVDD applied thereto, and the other end thereof may be connected to a gate electrode of the first switching transistor T1. The storage capacitor Cst may store a voltage of the gate electrode of the first switching transistor T1.

In one or more embodiments, an anode electrode of the light-emitting device 700 is connected to a source electrode of a seventh switching transistor T7 and a drain electrode of a sixth switching transistor T6. A cathode electrode of the light-emitting device 700 receives a low-potential base voltage ELVSS applied thereto. The light-emitting device 700 may emit light at a predetermined brightness by a driving current flowing through the first switching transistor T1. Here, a reset voltage VAR (e.g., initial2) is supplied to reset the anode electrode of the light emitting device 700.

In one or more embodiments, in a state in which a sixth transistor T6 located between the anode electrode of the light-emitting device 700 and the first switching transistor T1 is turned off by the emission signal EM, in case that the reset voltage VAR (e.g., initial2) is provided to the anode electrode of the light-emitting device 700, the anode electrode of the light-emitting device 700 may be reset.

In one or more embodiments, the first switching transistor T1 may correspond to a driving transistor. In one or more embodiments, the gate electrode of the first switching transistor T1 may be connected to the drain electrode of the third switching transistor T3. In one or more embodiments, the source electrode of the first switching transistor T1 may be connected to the drain electrode of the second switching transistor T2. In one or more embodiments, the drain electrode of the first switching transistor T1 may be connected to the source electrode of the third switching transistor T3. In one or more embodiments, the first switching transistor T1 may be turned on by a voltage difference between the source electrode and the drain electrode of the third switching transistor T3 and thus a driving current may be applied to the light-emitting device 700.

In one or more embodiments, the gate electrode of the third switching transistor T3 may receive a first scan signal Scanb[n]. In one or more embodiments, the drain electrode of the third switching transistor T3 may be connected to the gate electrode of the first switching transistor T1. In one or more embodiments, the source electrode of the third switching transistor T3 may be connected to the drain electrode of the first switching transistor T1. In one or more embodiments, the source electrode of the third switching transistor T3 may be connected to the source electrode of the sixth switching transistor T6. In one or more embodiments, the third switching transistor T3 may be turned on by the first scan signal Scanb[n] to control an operation of the first switching transistor T1 through the high-potential driving voltage (ELVDD) stored in the storage capacitor Cst. For example, the high-potential driving voltage ELVDD may have a value of about 2V to about 3V. In one or more embodiments, the third switching transistor T3 may include an N-type MOS transistor to configure an oxide transistor. The N-type MOS transistor uses an electron rather than a hole as a carrier, thus a movement speed is faster than the P-type MOS transistor, so the switching speed may be fast.

In one or more embodiments, the gate electrode of the second switching transistor T2 may receive a second scan signal Scan[n]. In one or more embodiments, the source electrode of the second switching transistor T2 may receive a data voltage Data. In one or more embodiments, the drain electrode of the second switching transistor T2 may be connected to the source electrode of the first switching transistor T1. In one or more embodiments, the second switching transistor T2 may be turned on by the second scan signal Scan[n] to provide the data voltage Data to the source electrode of the first switching transistor T1.

In one or more embodiments, the gate electrode of the fourth switching transistor T4 may receive a third scan signal Scanb[n−7]. In one or more embodiments, the source electrode of the fourth switching transistor T4 may receive a stabilization voltage Initial1. In one or more embodiments, the stabilization voltage Initial1 may be applied to the source electrode of the first switching transistor T1 within a mode operating at a low driving frequency, and may be divided, depending on a point of application, into an initialization voltage VINI to initialize the first switching transistor T1, a bias voltage VOBS to reduce a hysteresis of the first switching transistor T1, and a leakage suppression voltage VLS to reduce a leakage current. For example, the initialization voltage VINI may have a value of −6V to −4V, the bias voltage VOBS may have a value of 5V to 7V, and the leakage suppression voltage VLS may have a value of 2V to 5V. In one or more embodiments, the drain electrode of the fourth switching transistor T4 may be connected to the gate electrode of the first switching transistor T1. In one or more embodiments, the fourth switching transistor T4 may be turned on by the third scan signal Scanb[n−7] to provide the stabilization voltage Initial1 to the gate electrode of the first switching transistor T1.

In one or more embodiments, the gate electrode of the fifth switching transistor T5 may receive an emission signal Em[n]. In one or more embodiments, the source electrode of the fifth switching transistor T5 may receive a high-potential driving voltage ELVDD. In one or more embodiments, the drain electrode of the fifth switching transistor T5 may be connected to the source electrode of the first switching transistor T1. In one or more embodiments, the fifth switching transistor T5 may be turned on by the emission signal Em[n] to provide the high-potential driving voltage ELVDD to the source electrode of the first switching transistor T1.

In one or more embodiments, the gate electrode of the sixth switching transistor T6 may receive an emission signal Em[n]. In one or more embodiments, the source electrode of the sixth switching transistor T6 may be connected to the drain electrode of the first switching transistor T1. In one or more embodiments, the drain electrode of the sixth switching transistor T6 may be connected to the anode electrode of the light-emitting device 700. In one or more embodiments, the sixth switching transistor T6 may be turned on simultaneously with the fifth switching transistor T5 by the emission Em[n] and provide a driving current to the anode electrode of the light-emitting device 700.

In one or more embodiments, the gate electrode of the seventh switching transistor T7 may receive a fourth scan signal Scan[n+1]. Here, the fourth scan signal Scan[n+1] may correspond to the third scan signal Scanb[n−7] provided to the sub-pixel in another location. For example, in case that the third scan signal Scanb[n−7] is applied to an n-th gate line, the fourth scan signal Scan[n+1] may correspond to the third scan signal Scanb[n−7] provided to an (n+1)th gate line.

In one or more embodiments, the drain electrode of the seventh switching transistor T7 may receive a reset voltage Initial2. In one or more embodiments, the source electrode of the seventh switching transistor T7 may be connected to the anode electrode of the light-emitting device 700. In one or more embodiments, the seventh switching transistor T7 may be turned on by the fourth scan signal Scanb[n+1] to provide the reset voltage Initial2 to the anode electrode of the light-emitting device 700.

In one or more embodiments, the third scan signal Scanb[n−7] for applying the stabilization voltage Initial1 and the fourth scan signal Scanb[n+1] for controlling provision of the reset voltage initial2 to the anode electrode of the light-emitting device 700 may have different phases so that a driving operation of the first switching transistor T1 and an operation of resetting the anode electrode of the light-emitting device 700 may be performed separately. Here, when turning on the switching transistors T4 and T7 for providing the stabilization voltage Initial1 and the reset voltage Initial2, the sub-pixel may be configured to block a driving current of the first switching transistor T1 from flowing to the anode electrode of the light-emitting device 700 and ensure that the anode electrode is not affected by voltages other than the reset voltage Initial2 by turning off the sixth switching transistor T6 for connecting the source electrode of the first switching transistor T1 and the anode electrode of the light-emitting device 700.

As such, a sub-pixel including seven transistors T1, T2, T3, T4, T5, T6, and T7 and one capacitor Cst may be referred to as a 7T1C structure. Among various structures of sub-pixel circuits, the 7T1C structure is shown as an example, and the structure and number of transistors and capacitors included in the sub-pixel may be changed in various ways. Meanwhile, a plurality of sub-pixels may have the same structure, or some of the plurality of sub-pixels may have different structures.

In one or more embodiments, an electronic device (e.g., the electronic device 101, the processor 510, or the display driving circuit 537 in FIG. 5) may use a driving method for operating the light-emitting device 700 of the sub-pixel in a following order. For example, the display may correspond to an OLED using an oxide thin film transistor (TFT). For example, a low-temperature polycrystalline oxide (LTPO) manufacturing method may be used.

In one or more embodiments, as shown in FIG. 7A, the electronic device 101 may turn on the fifth switching transistor T5 and the sixth switching transistor T6 and emit a current determined by the first switching transistor T1 according to application of the high-potential driving voltage ELVDD to flow to the light-emitting device 700. In one or more embodiments, the electronic device 101 may turn off the third switching transistor T3.

In one or more embodiments, as shown in FIG. 7B, the electronic device 101 may turn on the fourth switching transistor T4 and initialize a current of the first switching transistor T1 and the light-emitting device 700.

In one or more embodiments, as shown in FIG. 7C, the electronic device 101 may turn off the fourth switching transistor T4 and turn on the second switching transistor T2 and the third switching transistor T3 so as to store a data voltage Data in the storage capacitor Cst. Here, a time for applying the data voltage Data may be limited not to overlap adjacent pixels. For example, assuming a vertical resolution of 3000 or higher and a refresh rate of 60 [Hz], the time for applying the data voltage Data may be limited to less than 5 [μs]. In one or more embodiments, the electronic device 101 may write data and compensate a voltage (ΔVt compensation).

In one or more embodiments, as shown in FIG. 7D, the electronic device 101 may turn off the second switching transistor T2, turn on the third switching transistor T3, and briefly turn on the seventh switching transistor T7 so as to discharge both electrodes of the light-emitting device 700. In one or more embodiments, the electronic device 101 may compensate a voltage (ΔVt compensation) and discharge the light0emitting device 700 (OLED discharging).

In one or more embodiments, as shown in FIG. 7E, the electronic device 101 may continuously discharge a voltage Vt while continuously turning on the third switching transistor T3. In one or more embodiments, the electronic device 101 may perform compensation with respect to a state in which a current of the first switching transistor T1 is sufficiently low.

In one or more embodiments, the electronic device 101 may perform an operation of FIG. 7A after an operation of FIG. 7E. In one or more embodiments, the electronic device 101 may sequentially perform operations shown in FIGS. 7A, 7B, 7C, 7D, and 7E.

The light-emitting device 700 corresponding to a sub-pixel may be connected to one gate line or one main source line so that a movement between pixels may be limited to integer units (1, 2, 3, . . . ). In this case, it may be difficult to expect a benefit of applying technologies that make the display appear to have a higher resolution than its physical resolution.

The electronic device 101 according to one or more embodiments may perform the Wobulation function for increasing resolution of an image received by the user by projecting a plurality of images by using a high operating frequency. For example, in case of the Wobulation function, when an image is projected by moving same in units of one pixel, a size of the pixel may become too large, and blur or staircase effect may be caused. In order to prevent the effect, because a pitch of the pixel may not be reduced indefinitely, and thus a display structure showing higher resolution at the same resolution may be required.

The electronic device 101 according to one or more embodiments may further include a first switching circuit 581 and a second switching circuit 583 as shown in FIG. 8. The electronic device 101 according to one or more embodiments may move and project the image at units less than one pixel unit (e.g., ½ pixel) through a switching operation of the first switching circuit 581 and/or the second switching circuit 583 so as to realize the Wobulation function.

In one or more embodiments, the pixel including a sub-pixel corresponding to the light-emitting device 700 may be connected to the first main gate line 571 to be electrically connected through the first switching circuit 581. In one or more embodiments, the first switching circuit 581 may be connected to the pixel including the sub-pixel corresponding to the light-emitting device 700 and a sub-pixel included in an adjacent pixel. In one or more embodiments, the first switching circuit 581 may selectively connect the first main gate line 571 to the light-emitting device 700 or the adjacent pixel.

In one or more embodiments, the pixel including the light-emitting device 700 may be connected to the first main source line 575 to be electrically connected through the second switching circuit 583. In one or more embodiments, the second switching circuit 583 may be connected a sub-pixel included in a pixel adjacent to the pixel including the light-emitting device 700. In one or more embodiments, the second switching circuit 583 may selectively connect the first main source line 575 to the light-emitting device 700 or the adjacent pixel.

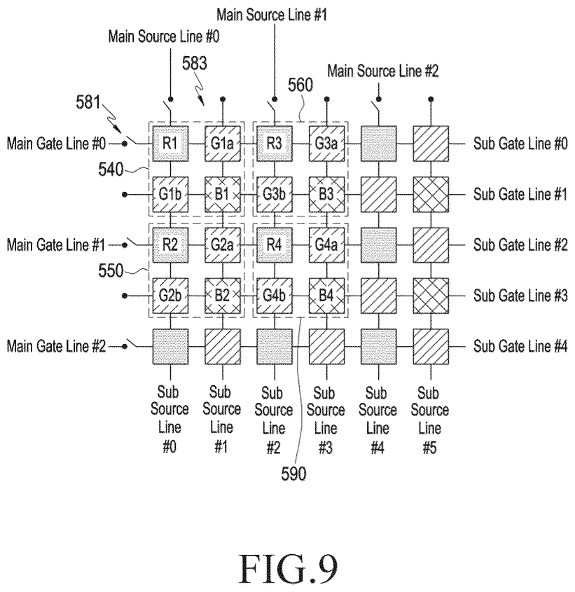

FIG. 9 is a diagram illustrating a connection structure of a display panel 535 according to one or more embodiments of the disclosure.

Referring to FIG. 9, in a display panel 535 of the electronic device 101 according to one or more embodiments, a plurality of pixels 540, 550, 560, and 590 may be arranged in a matrix form. In one or more embodiments, in the display panel 535, the plurality of pixels 540, 550, 560, and 590 may be arranged in a first direction (e.g., a horizontal direction) and a second direction (e.g., a vertical direction) intersecting the first direction. For example, the display panel 535 may include a first pixel 540, a second pixel 550 disposed in a second direction of the first pixel 540, a third pixel 560 disposed in a first direction of the first pixel 540, and a fourth pixel 590 disposed in a diagonal direction according to the first direction and the second direction of the first pixel 540.

In one or more embodiments, the display panel 535 may be connected to a first main gate line Main Gate Line #0, a second main gate line Main Gate Line #1, and a third main gate line Main Gate Line #2 which extend in the first direction (e.g., the horizontal direction). In one or more embodiments, the main gate lines Main Gate Line #0, #1, and #2 extending in the first direction may be connected to each of a plurality of pixels 540, 550, 560, and 590 arranged along the first direction. For example, each of a first pixel 540 and a third pixel 560 disposed in the first direction of the first pixel 540 may be connected to the first main gate line Main Gate Line #0 extending in the first direction.

In one or more embodiments, the display panel 535 may be connected to a first main source line Main Source Line #0, a second main source line Main Source Line #1, and a third main source line Main Source Line #2 which extend in the second direction (e.g., the vertical direction). In one or more embodiments, the main source lines extending in the second direction may be connected to each of the plurality of pixels 540, 550, 560, and 590 arranged along the second direction. For example, each of the first pixel 540 and the second pixel 550 disposed in the second direction of the first pixel 540 may be connected to the first source gate line Main Source Line #0 extending in the second direction.

In one or more embodiments, the plurality of pixels 540, 550, 560, and 590 may include a plurality of sub-pixels R1, G1a, G1b, B1, R2, G2a, G2b, B2, R3, G3a, G3b, B3, R4, G4a, G4b, and B4. In one or more embodiments, the plurality of pixels 540, 550, 560, and 590 may include different colored sub-pixels, such as a white sub-pixel, a red sub-pixel, a green sub-pixel, and/or a blue sub-pixel.

As shown in the drawing, the display panel 535 according to one or more embodiments may include pixels 540, 550, 560, and 590 each including four sub-pixels and correspond to an RGBG structure including one red sub-pixel R, one blue sub-pixel B, and two green sub-pixels Ga and Gb. For example, the display panel 535 may correspond to an RGBW structure including a white sub-pixel, a red sub-pixel, a green sub-pixel, and/or a blue sub-pixel.

In one or more embodiments, in each pixel 540, 550, 560, or 590, a plurality of sub-pixels R1, G1a, G1b, B1, R2, G2a, G2b, B2, R3, G3a, G3b, B3, R4, G4a, G4b, and B4 may be arranged in a first direction or a second direction. In one or more embodiments, as shown in the drawing, in each pixel 540, 550, 560, or 590, a plurality of sub-pixels R1, G1a, G1b, B1, R2, G2a, G2b, B2, R3, G3a, G3b, B3, R4, G4a, G4b, and B4 may be arranged in a matrix form in the first direction and the second direction.

In one or more embodiments, in each pixel 540, 550, 560, or 590, a plurality of sub-pixels R1, G1a, G1b, B1, R2, G2a, G2b, B2, R3, G3a, G3b, B3, R4, G4a, G4b, and B4 may be arranged in the first direction. In one or more embodiments, a first sub-source line Sub Source Line #0 and a second sub-source line Sub Source Line #1 each extending in the second direction may be arranged in the first direction. In one or more embodiments, the first sub-source line Sub Source Line #0 and the second sub-source line Sub Source Line #1 may be connected to the first main source line Main Source Line #0 and each may be connected to a plurality of sub-pixels R1, G1a, G1b, B1, R2, G2a, G2b, and B2 arranged in the second direction.

For example, a first red sub-pixel R1 and a first green sub-pixel b G1b included in the first pixel 540 may be arranged in the first direction together with a first green sub-pixel a G1a and a first blue sub-pixel B1, the first red sub-pixel R1 and the first green sub-pixel b G1b each may be connected to the first sub-source line Sub Source Line #0, and the first green sub-pixel a G1a and the first blue sub-pixel B1 each may be connected to the second sub-source line Sub Source Line #1.

In one or more embodiments, the first main source line Main Source Line #0 may be selectively connected, through the second switching circuit 583, to the first sub-source line Sub Source Line #0 of the first pixel 540 or the third sub-source line Sub Source Line #2 connected to a sub-pixel R3 or G3b of the third pixel 560 disposed in the first direction of the first pixel 540. In one or more embodiments, the first main source line Main Source Line #0 may be connected, by a switching operation of the second switching circuit 583, to the first sub-source line Sub Source Line #0 or to the third sub-source line Sub Source Line #2 connected to the sub-pixel R3 or G3b of the third pixel 560. Accordingly, the electronic device 101 may move the display panel 535 by ½ pixel (e.g., a half pixel) in the first direction.

In one or more embodiments, the first main source line Main Source Line #0 may be always connected to the second sub-source line Sub Source Line #1.

In one or more embodiments, in each pixel 540, 550, 560, or 590, a plurality of sub-pixels R1, G1a, G1b, B1, R2, G2a, G2b, B2, R3, G3a, G3b, B3, R4, G4a, G4b, and B4 may be arranged in the second direction and the first sub-gate line Sub Gate Line #0 and the sub-gate line Sub Gate Line #1 each extending in the first direction may be arranged in the second direction. In one or more embodiments, the first sub-gate line Sub Gate Line #0 and the second sub-gate line Sub Gate Line #1 may be connected to the first main gate line Main Gate Line #0 and each may be connected to a plurality of sub-pixels R1, G1a, G1b, B1, R3, G3a, G3b, and B3 arranged in the first direction.

For example, the first red sub-pixel R1 and the first green sub-pixel a G1a included in the first pixel 540 may be arranged in the second direction together with the first green sub-pixel b G1b and the first blue sub-pixel B1, the first red sub-pixel R1 and the first green sub-pixel a G1a each may be connected to the first sub-gate line Sub Gate Line #0, and the first green sub-pixel b G1b and the first blue sub-pixel B1 each may be connected to the second sub-gate line Sub Gate Line #1.

In one or more embodiments, the first main gate line Main Gate Line #0 may be selectively connected, through the first switching circuit 581, to the first sub-gate line Sub Gate Line #0 of the first pixel 540 or the third sub-gate line Sub Gate Line #2 connected to the sub-pixel R2 or G2a of the second pixel 550 disposed in the second direction of the first pixel 540. In one or more embodiments, the first main gate line Main Gate Line #0 may be connected, by a switching operation of the first switching circuit 581, to the first sub-gate line Sub Gate Line #0 or to the third sub-gate line Sub Gate Line #2 connected to the sub-pixel R2 or G2a of the second pixel 550. Accordingly, the electronic device 101 may move the display panel 535 by ½ pixel (e.g., a half pixel) in the second direction.

In one or more embodiments, the first main gate line Main Gate Line #0 may be always connected to the second sub-gate line Sub Gate Line #1.

According to one or more embodiments, each of the fourth sub-source line (Sub Source Line #3), the fifth sub-source line (Sub Source Line #4), the sixth sub-source line (Sub Source Line #5), the fourth sub-gate line (Sub Gate Line #3), and the fifth sub-gate line (Sub Gate Line #4) may be connected in the same manner as described above.

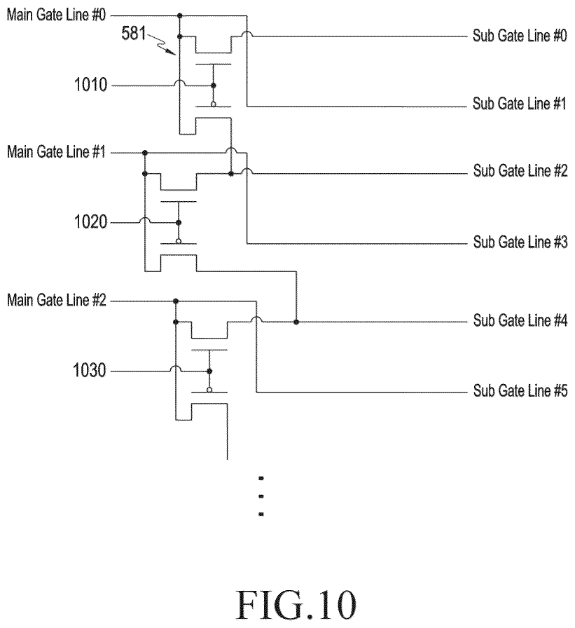

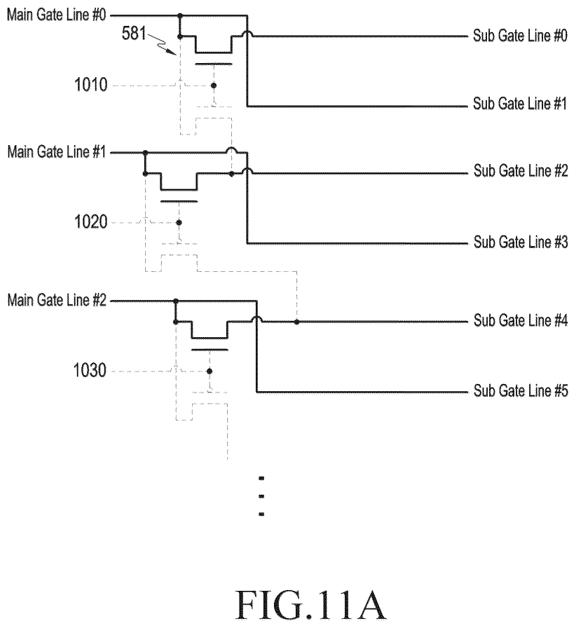

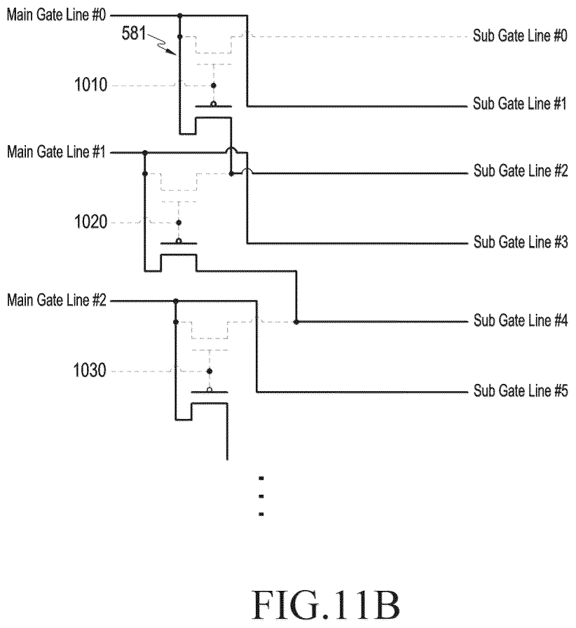

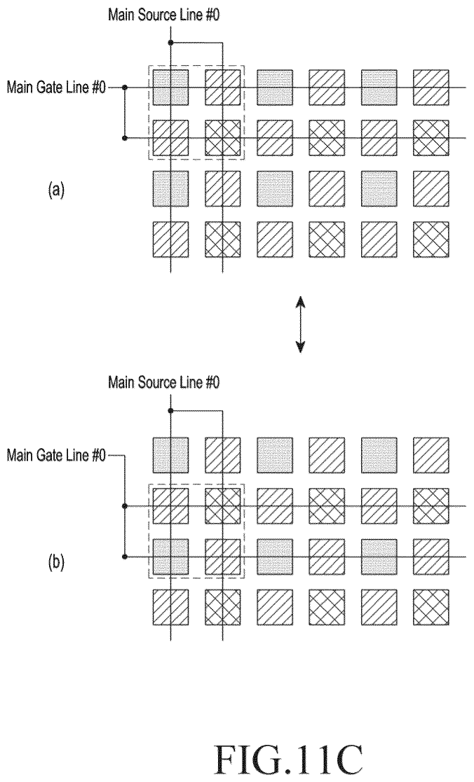

FIG. 10 is a diagram illustrating a first switching circuit 581 according to one or more embodiments of the disclosure. FIG. 11A is a control state diagram illustrating a low state of a first switching circuit 581 according to one or more embodiments of the disclosure. FIG. 11B is a control state diagram illustrating a high state of a first switching circuit 581 according to one or more embodiments of the disclosure. FIG. 11C is a diagram illustrating a driving state of a pixel according to a switching operation of a first switch according to one or more embodiments of the disclosure.

Referring to FIGS. 10, 11A, 11B, and 11C, the first switching circuit 581 according to one or more embodiments may include the first main gate line Main Gate Line #0 connected to the first sub-gate line Sub Gate Line #0, the second sub-gate line Sub Gate Line #1, and the third sub-gate line Sub Gate Line #2. The first main gate line Main Gate Line #0 according to one or more embodiments may be always connected to the second sub-gate line Sub Gate Line #1. The first switching circuit 581 according to one or more embodiments may include a first switch-a 1010 configured to selectively connect the first main gate line Main Gate Line #0 to the first sub-gate line Sub Gate Line #0 or the third sub-gate line Sub Gate Line #2, and the first main gate line Main Gate Line #0 may be connected to the first sub-gate line Sub Gate Line #0 or the third sub-gate line Sub Gate Line #2 through the first switch-a 1010.

In one or more embodiments, the first sub-gate line Sub Gate Line #0 and the second sub-gate line Sub Gate Line #1 each may extend in the first direction (e.g., the horizontal direction) and may be arranged in the second direction (e.g., the vertical direction) to correspond to a first row and a second row of the first pixel 540 included in the display panel 535, respectively. In one or more embodiments, the first sub-gate line Sub Gate Line #0 and the second sub-gate line Sub Gate Line #1 may be connected to sub-pixels R1 and G1a in a first row and sub-pixels G1b and B1 in a second row included in the first pixel 540, respectively.

In one or more embodiments, the first sub-gate line Sub Gate Line #0 and the second sub-gate line Sub Gate Line #1 may correspond to the first row and the second row corresponding to the third pixel 560 disposed in the first direction (e.g., the horizontal direction) of the first pixel 540, respectively. In one or more embodiments, the first sub-gate line Sub Gate Line #0 and the second sub-gate line Sub Gate Line #1 may be connected to the sub-pixels R3 and G3a in the first row and the sub-pixels G3b and B3 in the second row included in the third pixel 560, respectively.

The second main gate line Main Gate Line #1 according to one or more embodiments may be always connected to the fourth sub-gate line Sub Gate Line #3. The second main gate line Main Gate Line #1 according to one or more embodiments may be connected to the third sub-gate line Sub Gate Line #2 and the fifth sub-gate line Sub Gate Line #4 through the first switch-b 1020. In one or more embodiments, the first switch-b 1020 may selectively connect the second main gate line Main Gate Line #1 to the third sub-gate line Sub Gate Line #2 or the fifth sub-gate line Sub Gate Line #4.

In one or more embodiments, the third sub-gate line Sub Gate Line #2 and the fourth sub-gate line Sub Gate Line #3 may correspond to a third row and a fourth row corresponding to the second pixel 550 disposed in the second direction (e.g., the vertical direction) of the first pixel 540, respectively. In one or more embodiments, the third sub-gate line Sub Gate Line #2 and the fourth sub-gate line Sub Gate Line #3 may be connected to the sub-pixels R2 and G2a in the third row and the sub-pixels G2b and B2 in the fourth row included in the second pixel 550, respectively.

In one or more embodiments, the third main gate line Main Gate Line #2 may be always connected to the sixth sub-gate line corresponding to a sixth row and may be connected to the fifth sub-gate line Sub Gate Line #4 corresponding to a fifth row and the seventh sub-gate line corresponding to a sixth row, through the first switch-c 1030.

In one or more embodiments, as shown in FIG. 11A, the first switch-a 1010 may selectively connect the first main gate line Main Gate Line #0 to the first sub-gate line Sub Gate Line #0 in a low state. In one or more embodiments, the first switch-b 1020 may selectively connect the second main gate line Main Gate Line #1 to the third sub-gate line Sub Gate Line #2 in the low state. In one or more embodiments, the first switch-c 1030 may selectively connect the third main gate line Main Gate Line #2 to the fifth sub-gate line Sub Gate Line #4 in the low state. For example, the first switch-a 1010, the first switch-b 1020, and the first switch-c 1030 have been described as simultaneously operating in the same state, but may be operate individually or in different states.

In one or more embodiments, the first switch-a 1010 may selectively connect the first main gate line Main Gate Line #0 to the first sub-gate line Sub Gate Line #0 and the second sub-gate line Sub Gate Line #1 in the low state so as to drive sub-pixels R1, G1a, R3, and G3a corresponding to the first row and sub-pixels G1b, B1, G3b, and B3 corresponding to the second row of the display panel 535. In one or more embodiments, the first switch-b 1020 may selectively connect the second main gate line Main Gate Line #1 to the third sub-gate line Sub Gate Line #2 and the fourth sub-gate line Sub Gate Line #3 in the low state so as to drive sub-pixels R2, G2a, R4, and G4a corresponding to the third row and sub-pixels G2b, B2, G4b, and B4 corresponding to the fourth row of the display panel 535.

In one or more embodiments, as shown in FIG. 11B, the first switch-a 1010 may selectively connect the first main gate line Main Gate Line #0 to the third sub-gate line Sub Gate Line #2 in a high state. In one or more embodiments, the first switch-b 1020 may selectively connect the second main gate line Main Gate Line #1 to the fifth sub-gate line Sub Gate Line #4 in the high state. In one or more embodiments, the first switch-c 1030 may selectively connect the third main gate line Main Gate Line #2 to the seventh sub-gate line in the high state. For example, the first switch-a 1010, the first switch-b 1020, and the first switch-c 1030 have been described as simultaneously operating in the same state, but may be operate individually or in different states.

In one or more embodiments, the first switch-a 1010 may selectively connect the first main gate line Main Gate Line #0 to the second sub-gate line Sub Gate Line #1 and the third sub-gate line Sub Gate Line #2 in the high state so as to drive sub-pixels G1b, B1, G3b, and B3 corresponding to the second row and sub-pixels R2, G2a, R4, and G4a corresponding to the third row of the display panel 535. In one or more embodiments, the first switch-b 1020 may selectively connect the second main gate line Main Gate Line #1 to the fourth sub-gate line Sub Gate Line #3 and the fifth sub-gate line Sub Gate Line #4 in the high state so as to drive sub-pixels G2b, B2, G4b, and B4 corresponding to the fourth row and sub-pixels corresponding to the fifth row of the display panel 535.

As shown in part (a) in FIG. 11C, in one or more embodiments, the first pixel 540, the second pixel 550, the third pixel 560, and the fourth pixel 590 may be driven in designated positions in the low state of the first switch-a (e.g., the first switch-a 1010 in FIGS. 11A and 11B) and the first switch-b (e.g., the first switch-b 1020 in FIGS. 11A and 11B). As shown in part (b) in FIG. 11C, in one or more embodiments, the first switch-a 1010 and the first switch-b 1020 drive some of sub-pixels included in a pixel adjacent in the second direction (e.g., the vertical direction) in the high state so that the first pixel 540, the second pixel 550, the third pixel 560, and the fourth pixel 590 may be driven by moving in the second direction (e.g., the vertical direction) by ½ pixel.

In one or more embodiments, a display driving circuit (e.g., the display driving circuit 537 in FIG. 5) may control the first switch-a 1010 to connect the first main gate line Main Gate Line #0 to a first sub-pixel (e.g., the first sub-pixel 545 in FIG. 5 or the first red sub-pixel R1 in FIG. 9) included in the first pixel 540 and then connect the first main gate line Main Gate Line #0 to a second sub-pixel (e.g., the second sub-pixel 555 in FIG. 5 or the second red sub-pixel R2 in FIG. 9) included in the second pixel 550. Accordingly, the first pixel 540 may be moved in the second direction (e.g., the vertical direction) by ½ pixel and driven.

In one or more embodiments, the display driving circuit 537 may repeat the movement of ½ pixel by repeating the low and high states of the first switch 1010, 1020, or 1030. In one or more embodiments, the display driving circuit 537 may control the first switch 1010, 1020, or 1030 to move and drive the pixel and thus drive the pixel with different pixel data. In one or more embodiments, the display driving circuit 537 may drive the first sub-pixel R1 included in the first pixel 540 based on first pixel data and drive the second sub-pixel R2 included in the second pixel 550 based on second pixel data different from the first data. Accordingly, the display driving circuit 537 may implement the Wobulation function by driving pixel data while moving same in units smaller than one pixel.

In one or more embodiments, in case of driving the pixel while moving the pixel in the second direction, the display driving circuit 537 may control an operation of the first switch 1010, 1020, or 1030 at a frequency equivalent to two times a screen refresh rate of the display panel 535.

Here, although the embodiment in which sub-pixels included in one pixel are arranged in two rows is shown, the disclosure may be applied to a pixel including sub-pixels arranged in three rows. For example, in case of the embodiment including three rows, four sub-gate lines (e.g., three sub-gate lines of a corresponding pixel+one sub-gate line of an adjacent pixel) may be connected to a main gate line, and may be moved by ⅓ pixel by a switching operation of a switch to be driven.

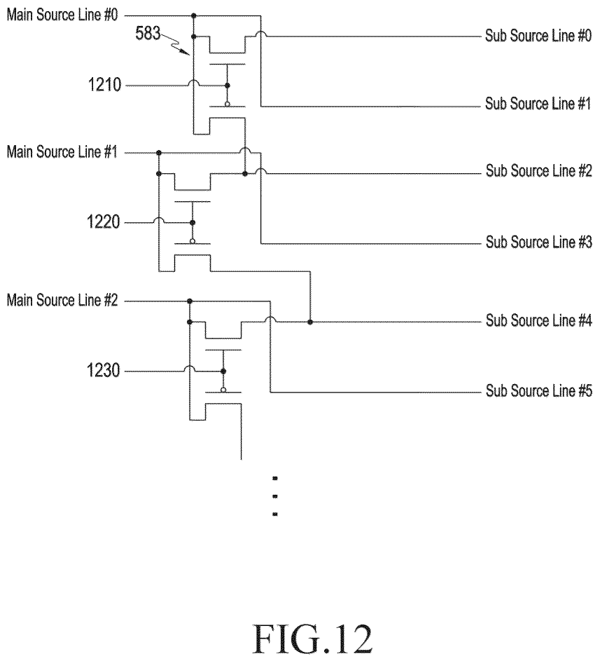

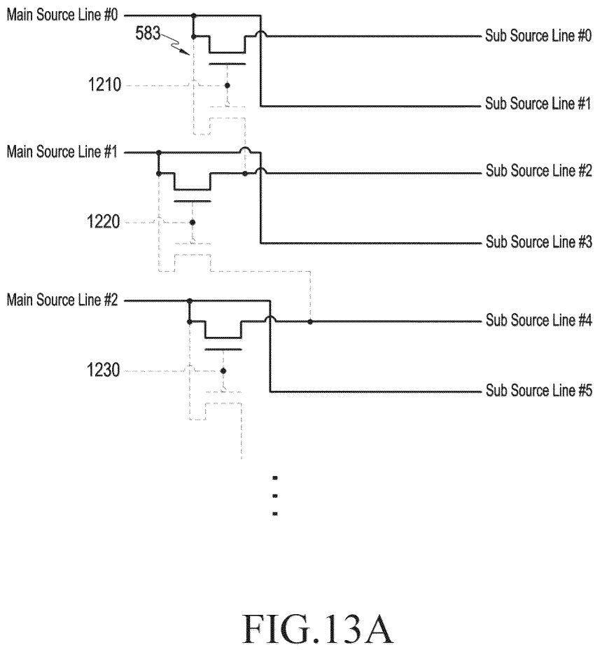

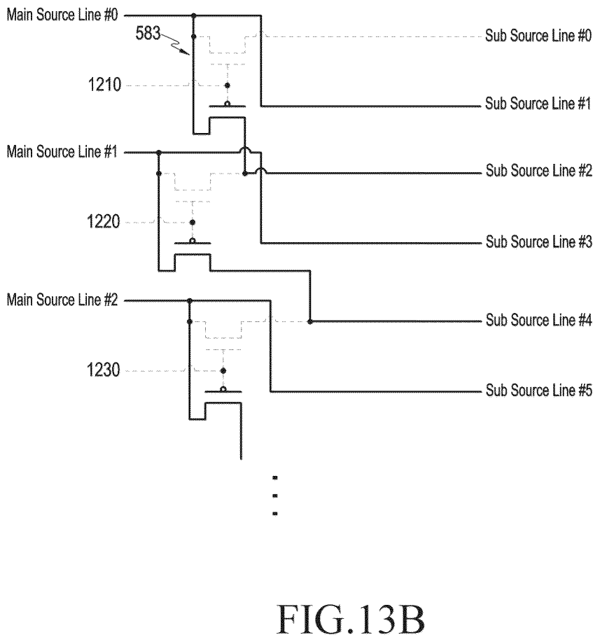

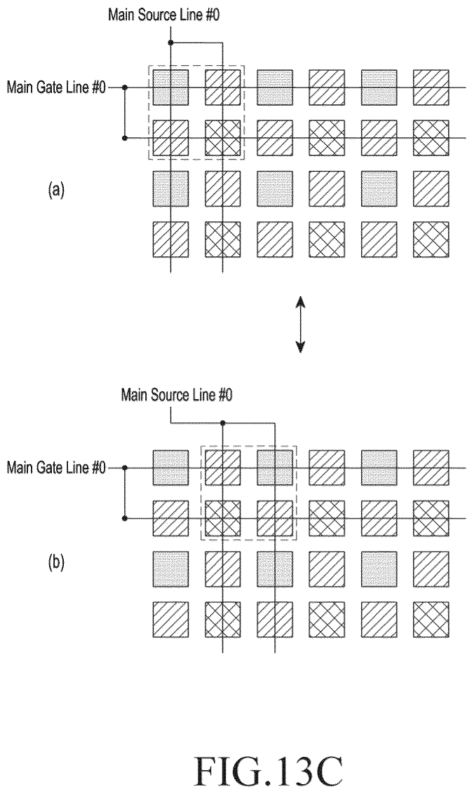

FIG. 12 is a diagram illustrating a second switching circuit 583 according to one or more embodiments of the disclosure. FIG. 13A is a control state diagram illustrating a low state of a second switching circuit 583 according to one or more embodiments of the disclosure. FIG. 13B is a control state diagram illustrating a high state of a second switching circuit 583 according to one or more embodiments of the disclosure. FIG. 13C is a diagram illustrating a driving state of a pixel according to a switching operation of a second switch according to one or more embodiments of the disclosure.

Referring to FIGS. 12, 13A, 13B, and 13C, the second switching circuit 583 according to one or more embodiments may include the first main source line Main Source Line #0 connected to the first sub-source line Sub Source Line #0, the second sub-source line Sub Source Line #1, and the third sub-source line Sub Source Line #2. The first main source line Main Source Line #0 according to one or more embodiments may be always connected to the second sub-source line Sub Source Line #1. The second switching circuit 583 according to one or more embodiments may include a second switch-a 1210 configured to selectively connect the first main source line Main Source Line #0 to the first sub-source line Sub Source Line #0 or the third sub-source line Sub Source Line #2, and the first main source line Main Source Line #0 may be connected to the first sub-source line Sub Source Line #0 or the third sub-source line Sub Source Line #2 through the second switch-a 1210.

In one or more embodiments, the first sub-source line Sub Source Line #0 and the second sub-source line Sub Source Line #1 each may extend in the second direction (e.g., the vertical direction) and may be arranged in the first direction (e.g., the horizontal direction) to correspond to a first column and a second column of the first pixel 540 included in the display panel 535, respectively. In one or more embodiments, the first sub-source line Sub Source Line #0 and the second sub-source line Sub Source Line #1 may be connected to the sub-pixels R1 and G1b in the first column and the sub-pixels G1a and B1 in the second column included in the first pixel 540, respectively.

In one or more embodiments, the first sub-source line Sub Source Line #0 and the second sub-source line Sub Source Line #1 may correspond to the first column and the second column corresponding to the second pixel 550 disposed in the second direction (e.g., the vertical direction) of the first pixel 540, respectively. In one or more embodiments, the first sub-source line Sub Source Line #0 and the second sub-source line Sub Source Line #1 may be connected to the sub-pixels R2 and G2b in the first column and the sub-pixels G2a and B2 in the second column included in the second pixel 550, respectively.

The second main source line Main Source Line #1 according to one or more embodiments may be always connected to the fourth sub-source line Sub Source Line #3. The second main source line Main Source Line #1 according to one or more embodiments may be connected to the third sub-source line Sub Source Line #2 and the fifth sub-source line Sub Source Line #4 through the second switch-b 1220. In one or more embodiments, the second switch-b 1220 may selectively connect the second main source line Main Source Line #1 to the third sub-source line Sub Source Line #2 or the fifth sub-source line Sub Source Line #4.

In one or more embodiments, the third sub-source line Sub Source Line #2 and the fourth sub-source line Sub Source Line #3 may correspond to the third column and the fourth column corresponding to the third pixel 560 disposed in the first direction (e.g., the horizontal direction) of the first pixel 540, respectively. In one or more embodiments, the third sub-source line Sub Source Line #2 and the fourth sub-source line Sub Source Line #3 may be connected to the sub-pixels R3 and G3b in the third column and the sub-pixels G3a and B3 in the fourth column included in the third pixel 560, respectively.

In one or more embodiments, the third main source line Main Source Line #2 may be always connected to the sixth sub-source line corresponding to a sixth column and may be connected to the fifth sub-source line Sub Source Line #4 corresponding to a fifth column and the seventh sub-source line corresponding to a seventh column, through the second switch-c 1230.

In one or more embodiments, as shown in FIG. 13A, the second switch-a 1210 may selectively connect the first main source line Main Source Line #0 to the first sub-source line Sub Source Line #0 in the low state. In one or more embodiments, the second switch-b may selectively connect the second main source line Main Source Line #1 to the third sub-source line Sub Source Line #2 in the low state. In one or more embodiments, the second switch-c 1230 may selectively connect the third main source line Main Source Line #2 to the fifth sub-source line Sub Source Line #4 in the low state. For example, the second switch-a 1210, the second switch-b 1220, and the second switch-c 1230 have been described as simultaneously operating in the same state, but may be operate individually or in different states.

In one or more embodiments, the second switch-a 1210 may selectively connect the first main source line Main Source Line #0 to the first sub-source line Sub Source Line #0 and the second sub-source line Sub Source Line #1 in the low state so as to drive sub-pixels R1, G1b, R2, and G2b corresponding to the first column and sub-pixels G1a, B1, G2a, and B2 corresponding to the second column of the display panel 535. In one or more embodiments, the second switch-b 1220 may selectively connect the second main source line Main Source Line #1 to the third sub-source line Sub Source Line #2 and the fourth sub-source line Sub Source Line #3 in the low state so as to drive sub-pixels R3, G3b, R4, and G4b corresponding to the third column and sub-pixels G3a, B3, G4a, and B4 corresponding to the fourth column of the display panel 535.

In one or more embodiments, as shown in FIG. 13B, the second switch-a 1210 may selectively connect the first main source line Main Source Line #0 to the third sub-source line Sub Source Line #2 in the high state. In one or more embodiments, the second switch-b 1220 may selectively connect the second main source line Main Source Line #1 to the fifth sub-source line Sub Source Line #4 in the high state. In one or more embodiments, the second switch-c 1230 may selectively connect the third main source line Main Source Line #2 to the seventh sub-source line in the high state. For example, the second switch-a 1210, the second switch-b 1220, and the second switch-c 1230 have been described as simultaneously operating in the same state, but may be operate individually or in different states.

In one or more embodiments, the second switch-a 1210 may selectively connect the first main source line Main Source Line #0 to the second sub-source line Sub Source Line #1 and the third sub-source line Sub Source Line #2 in the high state so as to drive sub-pixels G1a, B1, G2a, and B2 corresponding to the second column and sub-pixels R3, G3b, R4, and G4b corresponding to the third column of the display panel 535. In one or more embodiments, the second switch-b 1220 may selectively connect the second main source line Main Source Line #1 to the fourth sub-source line Sub Source Line #3 and the fifth sub-source line Sub Source Line #4 in the high state so as to drive sub-pixels G3a, B3, G4a, and B4 corresponding to the fourth column and sub-pixels corresponding to the fifth column of the display panel 535.

As shown in part (a) in FIG. 13C, in one or more embodiments, sub-pixels included in the first pixel 540, the second pixel 550, and the third pixel 560 may be driven in designated positions in the low state of the second switch-a (e.g., the second switch-a 1210 in FIGS. 13A and 13B) and the second switch-b (e.g., the second switch-b 1220 in FIGS. 13A and 13B). As shown in part (b) in FIG. 13C, in one or more embodiments, the second switch-a 1210 and the second switch-b 1220 drive some of sub-pixels included in a pixel adjacent in the first direction (e.g., the horizontal direction) in the high state so that the first pixel 540, the second pixel 550, the third pixel 560, and the fourth pixel 590 may be driven by moving in the first direction (e.g., the horizontal direction) by ½ pixel.

In one or more embodiments, the display driving circuit 537 may control the second switch-a 1210 to connect the first main source line Main Source Line #0 to the first sub-pixel R1 included in the first pixel 540 and then connect the first main source line Main Source Line #0 to the third sub-pixel (e.g., the third sub-pixel 565 in FIG. 5 or the third red sub-pixel R3 in FIG. 9) included in the third pixel 560. Accordingly, the first pixel 540 may be moved in the first direction (e.g., the horizontal direction) by ½ pixel and driven.

In one or more embodiments, the display driving circuit 537 may repeat the movement of ½ pixel by repeating the low and high states of the second switch 1210, 1220, or 1230. In one or more embodiments, the display driving circuit 537 may control the second switch to move and drive the pixel and thus drive the pixel with different pixel data. In one or more embodiments, the display driving circuit 537 may drive the first sub-pixel R1 included in the first pixel 540 based on first pixel data and drive the third sub-pixel R3 included in the third pixel 560 based on second pixel data different from the first pixel data. Accordingly, the display driving circuit 537 may implement the Wobulation function by driving pixel data while moving same in units smaller than one pixel.

In one or more embodiments, in case of driving the pixel while moving the pixel in the first direction, the display driving circuit 537 may control an operation of the second switch at a frequency equivalent to two times a screen refresh rate of the display panel 535.

Here, although the embodiment in which sub-pixels included in one pixel are arranged in two columns is shown, the disclosure may be applied to a pixel including sub-pixels arranged in three columns. For example, in case of the embodiment including three columns, four sub-source lines (e.g., three sub-source lines of a corresponding pixel+one sub-source line of an adjacent pixel) may be connected to a main source line, and may be moved by ⅓ pixel by a switching operation of a switch to be driven.

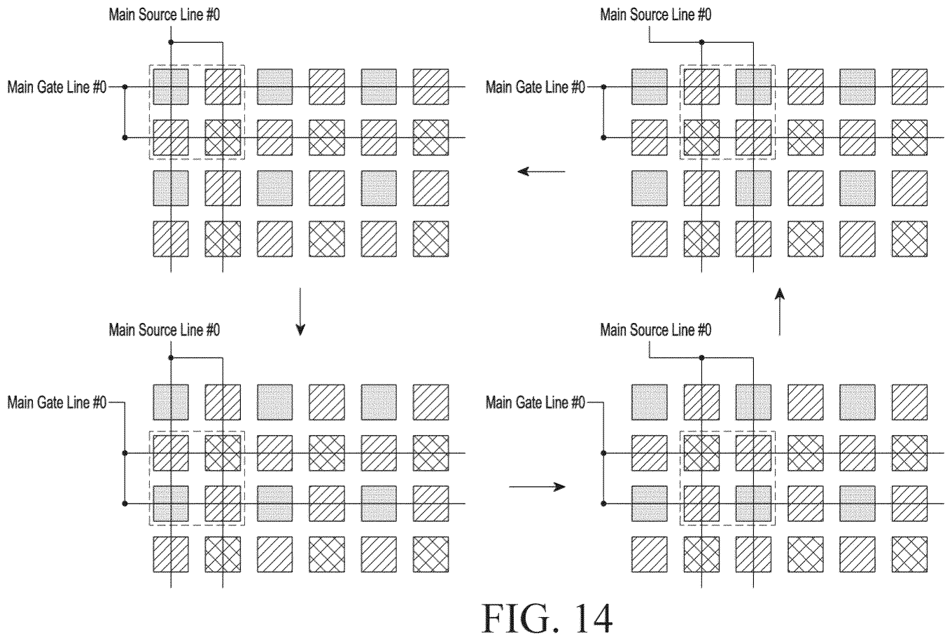

FIG. 14 is a diagram illustrating a driving state of a pixel according to a switching operation of a first switch (e.g., the first switch-a 1010, the first switch-b 1020, and the first switch-c 1030 in FIG. 10) and a second switch (e.g., the second switch-a 1210, the second switch-b 1220, and the second switch-c 1230 in FIG. 12) according to one or more embodiments of the disclosure.

Referring to FIG. 14, the plurality of pixels 540, 550, 560, and 590 included in the display panel 535 according to one or more embodiments may be arranged in the first direction (e.g., the horizontal direction) and the second direction (e.g., the vertical direction) so as to be arranged in a matrix form. The plurality of pixels included in the pixel according to one or more embodiments may be arranged in the first direction (e.g., the horizontal direction) and the second direction (e.g., the vertical direction) so as to be arranged in a matrix form.

In one or more embodiments, the first pixel 540 may be connected to the first main gate line Main Gate Line #0 and the first main source line Main Source Line #0. In one or more embodiments, the second pixel 550 disposed in the second direction (e.g., the vertical direction) of the first pixel 540 may be connected to the second main gate line Main Gate Line #1 and the first main source line Main Source Line #0. In one or more embodiments, the third pixel 560 disposed in the first direction (e.g., the horizontal direction) of the first pixel 540 may be connected to the first main gate line Main Gate Line #0 and the second main source line Main Source Line #1. In one or more embodiments, the fourth pixel 590 disposed in the first direction (e.g., the horizontal direction) of the second pixel 550 and/or the second direction (e.g., the vertical direction) of the third pixel 560 and disposed diagonally from the first pixel 540 in the first direction and the second direction may be connected to the second main gate line Main Gate Line #1 and the second main source line Main Source Line #1.

In one or more embodiments, a first sub pixel (e.g., the first sub-pixel 545 in FIG. 5 or the first red sub-pixel R1 in FIG. 9) included in the first pixel 540 may be connected to the first sub-gate line Sub Gate Line #0 and the first sub-source line Sub Source Line #0. In one or more embodiments, the first sub-gate line Sub Gate Line #0 may be connected to the first main gate line Main Gate Line #0 through the first switching circuit 581. In one or more embodiments, the first sub-source line Sub Source Line #0 may be connected to the first main source line Main Source Line #0 through the second switching circuit 583.

In one or more embodiments, a first common pixel (e.g., the first green sub-pixel b G1b in FIG. 9) included in the first pixel 540 may be disposed in the second direction of the first sub-pixel R1 to be adjacent to the second pixel 550 disposed in the second direction (e.g., the vertical direction) of the first pixel 540. In one or more embodiments, the first common pixel G1b may be connected to the second sub-gate line Sub Gate Line #1 and the first sub-source line Sub Source Line #0. In one or more embodiments, the second sub-gate line Sub Gate Line #1 may be always connected to the first main gate line Main Gate Line #0.

In one or more embodiments, a second common pixel (e.g., the first green sub-pixel a G1a in FIG. 9) included in the first pixel 540 may be disposed in the first direction of the first sub-pixel R1 to be adjacent to the third pixel 560 disposed in the first direction (e.g., the horizontal direction) of the first pixel 540. In one or more embodiments, the second common pixel G1a may be connected to the first sub-gate line Sub Gate Line #0 and the second sub-source line Sub Source Line #1. In one or more embodiments, the second sub-source line Sub Source Line #1 may be always connected to the first main source line Main Source Line #0.

In one or more embodiments, the second sub-pixel (e.g., the second sub-pixel in FIG. 5 or the second red sub-pixel R2 in FIG. 9) included in the second pixel 550 may be disposed along the second direction (e.g., the vertical direction) to be adjacent to the first pixel 540. In one or more embodiments, the second sub-pixel R2 may be connected to the third sub-gate line Sub Gate Line #2 and the first sub-source line Sub Source Line #0. In one or more embodiments, the third sub-gate line Sub Gate Line #2 may be connected to each of the first main gate line Main Gate Line #0 and the second main gate line Main Gate Line #1. In one or more embodiments, the first main gate line Main Gate Line #0 may be selectively connected to the first sub-gate line Sub Gate Line #0 or the third sub-gate line Sub Gate Line #2 through the first switching circuit 581.

In one or more embodiments, the third sub-pixel (e.g., the third sub-pixel 565 in FIG. 5 or the third red sub-pixel R3 in FIG. 9) included in the third pixel 560 may be disposed along the first direction (e.g., the horizontal direction) to be adjacent to the first pixel 540. In one or more embodiments, the third sub-pixel R3 may be connected to the first sub-gate line Sub Gate Line #0 and the third sub-source line Sub Source Line #2. In one or more embodiments, the third sub-source line Sub Source Line #2 may be connected to each of the first main source line Main Source Line #0 and the second main source line Main Source Line #1. In one or more embodiments, the first main source line Main Source Line #0 may be selectively connected to the first sub-source line Sub Source Line #0 or the third sub-source line Sub Source Line #2 through the second switching circuit 583.

In one or more embodiments, the fourth sub-pixel (e.g., the fourth red sub-pixel R4 in FIG. 9) included in the fourth pixel 590 may be disposed to be adjacent to the first pixel 540, the second pixel 550, and the third pixel 560 along the first direction (e.g., the horizontal direction) and the second direction (e.g., the vertical direction). In one or more embodiments, the fourth sub-pixel R4 may be connected to the third sub-gate line Sub Gate Line #2 and the third sub-source line Sub Source Line #2.

In one or more embodiments, the first switching circuit 581 may include the first switch 1010, 1020, and 1030 configured to selectively connect, to the first main gate line Main Gate Line #0, the first sub-gate line Sub Gate Line #0 connected to the first sub-pixel R1, the second common pixel G1a, and the third sub-pixel R3, or the third sub-gate line Sub Gate Line #2 extending parallel to the first sub-gate line Sub Gate Line #0 to be connected to the second sub-pixel R2.

In one or more embodiments, the second switching circuit 583 may include the second switch 1210, 1220, and 1230 configured to selectively connect, to the first main source line Main Source Line #0, the first sub-source line Sub Source Line #0 connected to the first sub-pixel R1, the first common pixel G1b, and the second sub-pixel R2, or the third sub-source line Sub Source Line #2 extending parallel to the first sub-source line Sub Source Line #0 to be connected to the third sub-pixel R3.

In one or more embodiments, the display driving circuit 537 may drive the first sub-pixel R1 and the second sub-pixel R2 alternately with each other by connecting the first sub-gate line Sub Gate Line #0 or the third sub-gate line Sub Gate Line #2 to the first main gate line Main Gate Line #0 alternately through a switching operation of the first switch 1010, 1020, or 1030. In one or more embodiments, the display driving circuit 537 may drive the first sub-pixel R1 based on first pixel data and drive the second sub-pixel R2 based on second pixel data different from the first pixel data.

In one or more embodiments, the display driving circuit 537 may drive the first sub-pixel R1 and the third sub-pixel R3 alternately with each other by connecting the first sub-source line Sub Source Line #0 or the third sub-source line Sub Source Line #2 to the first main source line Main Source Line #0 alternately through a switching operation of the second switch 1210, 1220, or 1230. In one or more embodiments, the display driving circuit 537 may drive the first sub-pixel R1 based on the first pixel data and drive the third sub-pixel R3 based on third pixel data different from the first pixel data.

In one or more embodiments, the display driving circuit 537 may drive the first sub-pixel R1 and the fourth sub-pixel R4 alternately with each other by connecting the first sub-gate line Sub Gate Line #0 or the third sub-gate line Sub Gate Line #2 to the first main gate line Main Gate Line #0 alternately and concurrently connecting the first sub-source line Sub Source Line #0 or the third sub-source line Sub Source Line #2 to the first main source line Main Source Line #0 alternately through a switching operation of the first switch 1010, 1020, or 1030 and the second switch 1210, 1220, or 1230. In one or more embodiments, the display driving circuit 537 may drive the first sub-pixel R1 based on the first pixel data and drive the fourth sub-pixel R4 based on fourth pixel data different from the first pixel data.

The display driving circuit 537 according to one or more embodiments may move the pixel in the first direction, the second direction, and/or a diagonal direction of the first direction and the second direction by units smaller than one pixel and drive the pixel.

As shown in FIG. 14, the display driving circuit 537 according to one or more embodiments may control the first switch 1010, 1020, or 1030 and the second switch 1210, 1220, or 1230 to connect the first main gate line Main Gate Line #0 to the first sub-gate line Sub Gate Line #0 and connect the first main source line Main Source Line #0 to the first sub-source line Sub Source Line #0. In one or more embodiments, the display driving circuit 537 may drive the first pixel 540 at a designated location as it is. The display driving circuit 537 according to one or more embodiments may drive the first sub-pixel R1 based on the first pixel data.

The display driving circuit 537 according to one or more embodiments may control the first switch 1010, 1020, or 1030 and the second switch 1210, 1220, or 1230 to connect the first main gate line Main Gate Line #0 to the third sub-gate line Sub Gate Line #2 and connect the first main source line Main Source Line #0 to the first sub-source line Sub Source Line #0. In one or more embodiments, the display driving circuit 537 may drive the first pixel 540 at a location moved by ½ pixel in the second direction (e.g., the vertical direction). The display driving circuit 537 according to one or more embodiments may drive the second sub-pixel R2 based on the second pixel data different from the first pixel data.

The display driving circuit 537 according to one or more embodiments may control the first switch 1010, 1020, or 1030 and the second switch 1210, 1220, or 1230 to connect the first main gate line Main Gate Line #0 to the third sub-gate line Sub Gate Line #2 and connect the first main source line Main Source Line #0 to the third sub-source line Sub Source Line #2. In one or more embodiments, the display driving circuit 537 may drive the first pixel 540 at a location moved by 1/V 2 pixel in a diagonal direction according to the first direction (e.g., the horizontal direction) and the second direction (e.g., the vertical direction). The display driving circuit according to one or more embodiments may drive the fourth sub-pixel R4 based on fourth pixel data different from the first pixel data and the second pixel data.

The display driving circuit 537 according to one or more embodiments may control the first switch 1010, 1020, or 1030 and the second switch 1210, 1220, or 1230 to connect the first main gate line Main Gate Line #0 to the first sub-gate line Sub Gate Line #0 and connect the first main source line Main Source Line #0 to the third sub-source line Sub Source Line #2. In one or more embodiments, the display driving circuit 537 may drive the first pixel 540 at a location moved by ½ pixel in the first direction (e.g., the horizontal direction). The display driving circuit 537 according to one or more embodiments may drive the third sub-pixel R3 based on third pixel data different from the first pixel data, the second pixel data, and the fourth pixel data.

The display driving circuit 537 according to one or more embodiments may control the first switch 1010, 1020, or 1030 and the second switch 1210, 1220, or 1230 to connect the first main gate line Main Gate Line #0 to the first sub-gate line Sub Gate Line #0 and connect the first main source line Main Source Line #0 to the first sub-source line Sub Source Line #0 again so as to repeat the control operation.

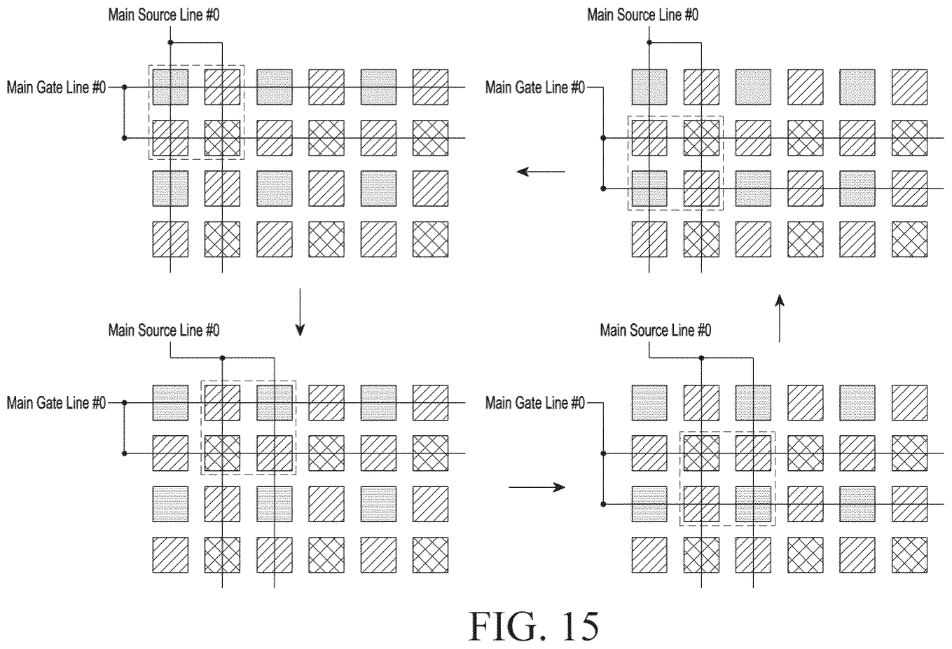

FIG. 15 is a diagram illustrating a driving state of a pixel according to a switching operation of a first switch (e.g., the first switch 1010, 1020, or 1030 in FIG. 10) and a second switch (e.g., the second switch 1210, 1220, or 1230 in FIG. 12) according to one or more embodiments of the disclosure.

Referring to FIG. 15, the display driving circuit 537 according to one or more embodiments may control the first switch 1010, 1020, or 1030 and the second switch 1210, 1220, or 1230 to connect the first main gate line Main Gate Line #0 to the first sub-gate line Sub Gate Line #0 and connect the first main source line Main Source Line #0 to the first sub-source line Sub Source Line #0. In one or more embodiments, the display driving circuit 537 may drive the first pixel 540 at a designated location as it is. The display driving circuit 537 according to one or more embodiments may drive the first sub-pixel R1 based on the first pixel data.

The display driving circuit 537 according to one or more embodiments may control the first switch 1010, 1020, or 1030 and the second switch 1210, 1220, or 1230 to connect the first main gate line Main Gate Line #0 to the first sub-gate line Sub Gate Line #0 and connect the first main source line Main Source Line #0 to the third sub-source line Sub Source Line #2. In one or more embodiments, the display driving circuit 537 may drive the first pixel 540 at a location moved by ½ pixel in the first direction (e.g., the horizontal direction). The display driving circuit 537 according to one or more embodiments may drive the third sub-pixel R3 based on the third pixel data different from the first pixel data.

The display driving circuit 537 according to one or more embodiments may control the first switch 1010, 1020, or 1030 and the second switch 1210, 1220, or 1230 to connect the first main gate line Main Gate Line #0 to the third sub-gate line Sub Gate Line #2 and connect the first main source line Main Source Line #0 to the third sub-source line Sub Source Line #2. In one or more embodiments, the display driving circuit 537 may drive the first pixel 540 at a location moved by 1/V 2 pixel in the first direction (e.g., the horizontal direction) and the second direction (e.g., the vertical direction). The display driving circuit 537 according to one or more embodiments may drive the fourth sub-pixel R4 based on fourth pixel data different from the first pixel data and the third pixel data.

The display driving circuit 537 according to one or more embodiments may control the first switch 1010, 1020, or 1030 and the second switch 1210, 1220, or 1230 to connect the first main gate line Main Gate Line #0 to the third sub-gate line Sub Gate Line #2 and connect the first main source line Main Source Line #0 to the first sub-source line Sub Source Line #0. In one or more embodiments, the display driving circuit may drive the first pixel 540 at a location moved by ½ pixel in the second direction (e.g., the vertical direction). The display driving circuit 537 according to one or more embodiments may drive the second sub-pixel R2 based on the second pixel data different from the first pixel data, the third pixel data, and the fourth pixel data.

The display driving circuit 537 according to one or more embodiments may control the first switch 1010, 1020, or 1030 and the second switch 1210, 1220, or 1230 to connect the first main gate line Main Gate Line #0 to the first sub-gate line Sub Gate Line #0 and connect the first main source line Main Source Line #0 to the first sub-source line Sub Source Line #0 again so as to repeat the control operation.

Therefore, the display driving circuit 537 may implement the Wobulation function by driving pixel data while moving same in units smaller than one pixel.

In one or more embodiments, in case of driving the pixel while sequentially moving the pixel in the first direction, the diagonal direction of the first direction and the second direction, and the second direction, the display driving circuit 537 may control an operation of the first switch 1010, 1020, or 1030 and the second switch 1210, 1220, or 1230 at a frequency equivalent to four times a screen refresh rate of the display panel 535.

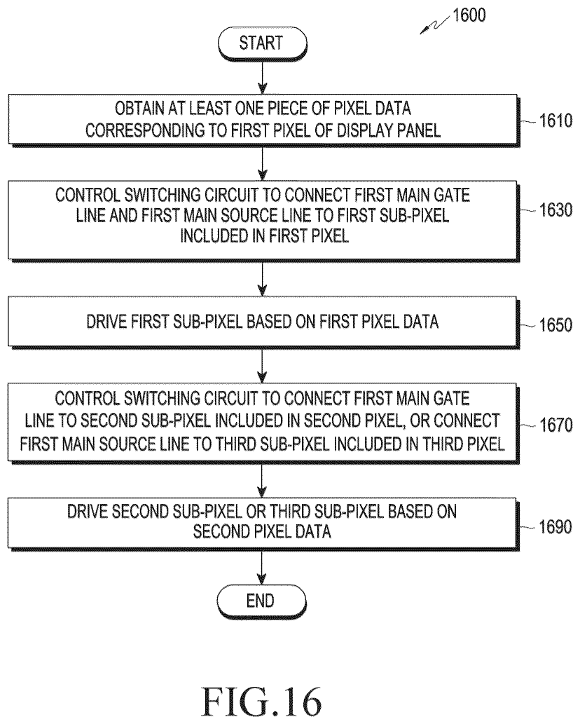

FIG. 16 is a flowchart 1600 illustrating an operating method of an electronic device 101, 200, or 300 according to one or more embodiments of the disclosure.

Referring to FIG. 16, the electronic device 101, 200, or 300 according to one or more embodiments may acquire, in operation 1610, at least one piece of pixel data corresponding to the first pixel 540 of the display panel 535. In one or more embodiments, the electronic device 101, 200, or 300 may acquire first pixel data and second pixel data corresponding to the first pixel 540.

The electronic device 101, 200, or 300 according to one or more embodiments may control, in operation 1630, the switching circuit 580, 581, or 583 to connect the first main gate line 571 Main Gate Line #0 and the first main source line 575 Main Source Line #0 to the first sub-pixel R1 included in the first pixel 540. The electronic device 101, 200, or 300 according to one or more embodiments may drive the first pixel 540 at a designated location.

The electronic device 101, 200, or 300 according to one or more embodiments may drive, in operation 1650, the first pixel 540 based on the first pixel data.

The electronic device 101, 200, or 300 according to one or more embodiments may control, in operation 1670, the switching circuit 580, 581, or 583 to connect the first main gate line 571 Main Gate Line #0 to the second sub-pixel R2 included in the second pixel 550 or connect the first main source line 575 Main Source Line #0 to the third sub-pixel R3 included in the third pixel 560. The electronic device 101, 200, or 300 according to one or more embodiments may drive the first pixel 540 at a location moved by ½ pixel in the first direction or the second direction.

The electronic device 101, 200, or 300 according to one or more embodiments may drive, in operation 1690, the second sub-pixel R2 or the third sub-pixel R3 based on the second pixel data. In one or more embodiments the second pixel data may be different from the first pixel data.

The electronic device 101, 200, or 300 according to one or more embodiments may perform operation 1610 to operation 1690 after performing operation 1690 so as to implement the Wobulation function by moving the first pixel 540 by ½ pixel in the first direction or the second direction.

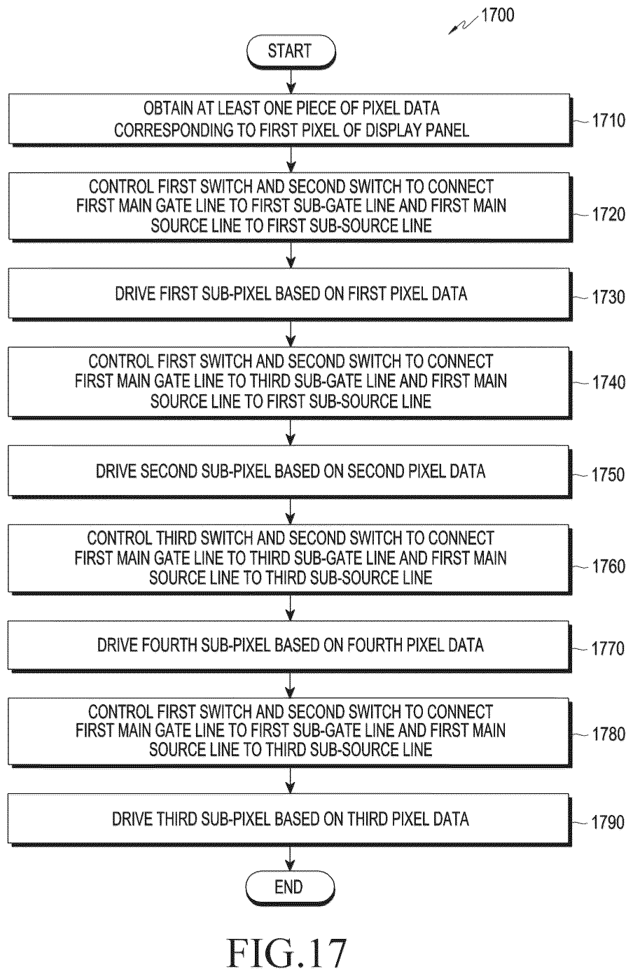

FIG. 17 is a flowchart 1700 illustrating an operating method of an electronic device 101, 200, or 300 according to one or more embodiments of the disclosure.

Referring to FIG. 17, the electronic device 101, 200, or 300 according to one or more embodiments may acquire, in operation 1710, at least one piece of pixel data corresponding to the first pixel 540 of the display panel 535. In one or more embodiments, the electronic device 101, 200, or 300 may acquire first pixel data, second pixel data, third pixel data, and fourth pixel data. In one or more embodiments, the electronic device 101, 200, or 300 may drive the first pixel 540 to correspond to each of the first pixel data, the second pixel data, the third pixel data, and the fourth pixel data while moving.

The electronic device 101, 200, or 300 according to one or more embodiments may control, in operation 1720, the first switch 1010, 1020, or 1030 and the second switch 1210, 1220, or 1230 to connect the first main gate line 571 Main Gate Line #0 to the first sub-gate line Sub Gate Line #0 and connect the first main source line 575 Main Source Line #0 to the first sub-source line Sub Source Line #0.

The electronic device 101, 200, or 300 according to one or more embodiments may drive, in operation 1730, the first sub-pixel R1 based on the first pixel data. In one or more embodiments, the electronic device 101, 200, or 300 may drive the first pixel 540 based on the first pixel data at a designated location without moving same.

The electronic device 101, 200, or 300 according to one or more embodiments may control, in operation 1740, the first switch 1010, 1020, or 1030 and the second switch 1210, 1220, or 1230 to connect the first main gate line 571 Main Gate Line #0 to the third sub-gate line Sub Gate Line #2 and connect the first main source line 575 Main Source Line #0 to the first sub-source line Sub Source Line #0.

The electronic device 101, 200, or 300 according to one or more embodiments may drive, in operation 1750, the second sub-pixel R2 based on the second pixel data. In one or more embodiments, the electronic device 101, 200, or 300 may drive the first pixel 540 by moving the first pixel by ½ pixel in the second direction.

The electronic device 101, 200, or 300 according to one or more embodiments may control, in operation 1760, the first switch 1010, 1020, or 1030 and the second switch 1210, 1220, or 1230 to connect the first main gate line 571 Main Gate Line #0 to the third sub-gate line Sub Gate Line #2 and connect the first main source line 575 Main Source Line #0 to the third sub-source line Sub Source Line #2.

The electronic device 101, 200, or 300 according to one or more embodiments may drive, in operation 1770, the fourth sub-pixel based on the fourth pixel data. In one or more embodiments, the electronic device 101, 200, or 300 may drive the first pixel 540 by moving the first pixel by 1/V 2 pixel in a diagonal direction according to the first direction and the second direction.

The electronic device 101, 200, or 300 according to one or more embodiments may control, in operation 1780, the first switch 1010, 1020, or 1030 and the second switch 1210, 1220, or 1230 to connect the first main gate line 571 Main Gate Line #0 to the first sub-gate line Sub Gate Line #0 and connect the first main source line 575 Main Source Line #0 to the third sub-source line Sub Source Line #2.

The electronic device 101, 200, or 300 according to one or more embodiments may drive, in operation 1790, the third sub-pixel R3 based on the third pixel data. In one or more embodiments, the electronic device 101, 200, or 300 may drive the first pixel 540 by moving the first pixel by ½ pixel in the first direction.

The technical problems solved by the disclosure are not limited to the above technical problems and those skilled in the art will more clearly understand other technical problems from the following description.

It will be appreciated by a person skilled in the art that effects which may be achieved from the disclosure are not limited to the effects described above and other effects that are not described above will be clearly understood from the following detailed description.

An electronic device 101, 200, or 300 according to one or more embodiments of the disclosure may include a display panel 535 in which a plurality of pixels 540, 550, 560, and 590 are arranged in a matrix form.

The electronic device according to one or more embodiments may include the first main gate line 571 Main Gate Line #0 extending in a first direction and configured to be electrically connectible to the first pixel 540 among the plurality of pixels 540, 550, 560, and 590.

The electronic device according to one or more embodiments may include the second main gate line 573 Main Gate Line #1 extending in the first direction and configured to be electrically connectible to the second pixel 550 among the plurality of pixels 540, 550, 560, and 590.

The second pixel 550 according to one or more embodiments may be disposed adjacent to the first pixel 540 along the second direction intersecting the first direction.

The electronic device according to one or more embodiments may include the first main source line 575 Main Source Line #0 extending in the second direction and configured to be electrically connectible to the first pixel 540.

The electronic device according to one or more embodiments may include the second main source line 577 Main Source Line #1 extending in the second direction and configured to be electrically connectible to the third pixel 560 among the plurality of pixels 540, 550, 560, and 590.

The third pixel 560 according to one or more embodiments may be disposed in the first direction of the first pixel 540.

The electronic device according to one or more embodiments may include the switching circuit 580, 581, or 583 which is connected to one of the first main gate line 571 Main Gate Line #0 or the first main source line 575 Main Source Line #0 and configured to selectively connect the first main gate line 571 Main Gate Line #0 to the first sub-pixel 545 R1 included in the first pixel 540 or the second sub-pixel 555 R2 included in the second pixel 550, or selectively connect the first main source line 575 Main Source Line #0 to the first sub-pixel 545 R1 or the third sub-pixel 565 R3 included in the third pixel 560.

The electronic device according to one or more embodiments may include the display driving IC 537 or 430 (display driving IC (DDI)) electrically connected to the display panel 535 and configured to drive the display panel 535.

The electronic device 101, 200, or 300 according to one or more embodiments may further include the first transistor array 543 electrically connected to the first main gate line 571 Main Gate Line #0 and the first main source line 575 Main Source Line #0 and configured to drive the first sub-pixel 545 R1.

In the electronic device 101, 200, or 300 according to one or more embodiments, the switching circuit 580, 581, or 583 may be connected between the first main gate line 571 Main Gate Line #0 or the first main source line 575 Main Source Line #0 and the first transistor array 543.

In the electronic device 101, 200, or 300 according to one or more embodiments, the first pixel 540 may have a plurality of sub-pixels including the first sub-pixel 545 R1 arranged in the first direction or the second direction.

In the electronic device 101, 200, or 300 according to one or more embodiments, the switching circuit 580, 581, or 583 may include at least one switch 1010, 1020, 1030, 1210, 1220, or 1230 each corresponding to at least part of the plurality of sub-pixels.

The electronic device 101, 200, or 300 according to one or more embodiments may further include a lens (display member 201) disposed in front of the display panel 535.

In the electronic device 101, 200, or 300 according to one or more embodiments, the first pixel 540 may be located in an edge area of the display panel 535.

In the electronic device 101, 200, or 300 according to one or more embodiments, the display driving circuit 537 or 430 may be configured to control the switching circuit 580, 581, or 583 to connect the first main gate line 571 Main Gate Line #0 and the first main source line 575 Main Source Line #0 to the first sub-pixel 545 R1.

The display driving circuit 537 or 430 according to one or more embodiments may be configured to drive the first sub-pixel 545 R1 based on the first pixel data. The display driving circuit 537 or 430 may be configured to control the switching circuit 580, 581, or 583 to connect the first main gate line 571 Main Gate Line #0 to the second sub-pixel 555 R2 or connect the first main source line 575 Main Source Line #0 to the third sub-pixel 565 R3.

The display driving circuit 537 or 430 according to one or more embodiments may be configured to drive the second sub-pixel 555 R2 or the third sub-pixel 565 R3 based on the second pixel data different from the first pixel data.

In the electronic device 101, 200, or 300 according to one or more embodiments, the first pixel 540 may have a plurality of sub-pixels including the first sub-pixel 545 R1 arranged in the second direction.

In the electronic device 101, 200, or 300 according to one or more embodiments, the second pixel 550 may have a plurality of sub-pixels including the second sub-pixel 555 R2 arranged along the second direction.

In the electronic device 101, 200, or 300 according to one or more embodiments, the second sub-pixel 555 R2 may be disposed adjacent to the first pixel 540 along the second direction.

In the electronic device 101, 200, or 300 according to one or more embodiments, the switching circuit 580, 581, or 583 may include the first switching circuit 580, 581, or 583 connected to the first main gate line 571 Main Gate Line #0 and configured to selectively connect the first main gate line 571 Main Gate Line #0 to the first sub-pixel 545 R1 or the second sub-pixel 555 R2.

In the electronic device 101, 200, or 300 according to one or more embodiments, the first switching circuit 580, 581, or 583 may include the first switch 1010, 1020, or 1030 configured to selectively connect, to the first main gate line 571 Main Gate Line #0, the first sub-gate line Sub Gate Line #0 which connects the first main gate line 571 Main Gate Line #0 to the first sub-pixel 545 R1, or the third sub-gate line Sub Gate Line #2 which connects the first main gate line 571 Main Gate Line #0 to the second sub-pixel 555 R2.

The display driving circuit 537 or 430 according to one or more embodiments may be configured to control the first switch 1010, 1020, or 1030 to connect the first main gate line 571 Main Gate Line #0 to the first sub-pixel 545 R1 and then connect the first main gate line 571 Main Gate Line #0 to the second sub-pixel 555 R2.

In the electronic device 101, 200, or 300 according to one or more embodiments, the first pixel 540 may have a plurality of sub-pixels including the first sub-pixel 545 R1 arranged in the first direction.

In the electronic device 101, 200, or 300 according to one or more embodiments, the third pixel 560 may have a plurality of sub-pixels including the third sub-pixel 565 R3 arranged in the first direction.

In the electronic device 101, 200, or 300 according to one or more embodiments, the third sub-pixel 565 R3 may be disposed adjacent to the first pixel 540 along the first direction.

In the electronic device 101, 200, or 300 according to one or more embodiments, the switching circuit 580, 581, or 583 may include the second switching circuit 580, 581, or 583 connected to the first main source line 575 Main Source Line #0 and configured to selectively connect the first main source line 575 Main Source Line #0 to the first sub-pixel 545 R1 or the third sub-pixel 565 R3.

In the electronic device 101, 200, or 300 according to one or more embodiments, the second switching circuit 580, 581, or 583 may include the second switch 1210, 1220, or 1230 configured to selectively connect, to the first main source line 575 Main Source Line #0, the first sub-source line Sub Source Line #0 which connects the first main source line 575 Main Source Line #0 to the first sub-pixel 545 R1, or the third sub-source line Sub Source Line #2 which connects the first main source line 575 Main Source Line #0 to the second sub-pixel 555 R2.

In the electronic device 101, 200, or 300 according to one or more embodiments, the display driving circuit 537 or 430 may be configured to control the second switch 1210, 1220, or 1230 to connect the first main source line 575 Main Source Line #0 to the first sub-pixel 545 R1 and then connect the first main source line 575 Main Source Line #0 to the third sub-pixel 565 R3.

In the electronic device 101, 200, or 300 according to one or more embodiments, a plurality of sub-pixels may be arranged in a matrix form along the first direction and the second direction in the first pixel 540, the second pixel 550, and the third pixel 560.

In the electronic device 101, 200, or 300 according to one or more embodiments, the second sub-pixel 555 R2 may be disposed adjacent to the first pixel 540 along the second direction. In the electronic device 101, 200, or 300 according to one or more embodiments, the third sub-pixel 565 R3 may be disposed adjacent to the first pixel 540 along the first direction.

In the electronic device 101, 200, or 300 according to one or more embodiments, the switching circuit 580, 581, or 583 may include the first switching circuit 580, 581, or 583 connected to the first main gate line 571 Main Gate Line #0 and configured to selectively connect the first main gate line 571 Main Gate Line #0 to the first sub-pixel 545 R1 or the second sub-pixel 555 R2, and the second switching circuit 580, 581, or 583 connected to the first main source line 575 Main Source Line #0 and configured to selectively connect the first main source line 575 Main Source Line #0 to the first sub-pixel 545 R1 or the third sub-pixel 565 R3.

In the electronic device 101, 200, or 300 according to one or more embodiments, the display driving circuit 537 or 430 may be configured to control the switching circuit 580, 581, or 583 to connect the first main gate line 571 Main Gate Line #0 and the first main source line 575 Main Source Line #0 to the first sub-pixel 545 R1.

The display driving circuit 537 or 430 according to one or more embodiments may be configured to drive the first sub-pixel 545 R1 based on the first pixel data.

The display driving circuit 537 or 430 according to one or more embodiments may be configured to control the first switching circuit 580, 581, or 583 to connect the first main gate line 571 Main Gate Line #0 to the second sub-pixel 555 R2.

The display driving circuit 537 or 430 according to one or more embodiments may be configured to drive the second sub-pixel 555 R2 based on the second pixel data different from the first pixel data.

The display driving circuit 537 or 430 according to one or more embodiments may be configured to control the second switching circuit 580, 581, or 583 to connect the first main source line 575 Main Source Line #0 to the third sub-pixel 565 R3.

The display driving circuit 537 or 430 according to one or more embodiments may be configured to drive the third sub-pixel 565 R3 based on the third pixel data different from the first pixel data and the second pixel data.

An operating method of an electronic device 101, 200, or 300 according to one or more embodiments may include an operation 1610 or 1710 of obtaining at least one piece of pixel data corresponding to a first pixel 540 of a display panel 535.

The operating method of the electronic device 101, 200, or 300 according to one or more embodiments may include an operation 1630 or 1720 of controlling a switching circuit 580, 581, or 583 to connect a first main gate line 571 Main Gate Line #0 configured to be electrically connectible to the first pixel 540 and a first main source line 575 Main Source Line #0 to a first sub-pixel 545 R1 included in the first pixel 540.

The operating method of the electronic device 101, 200, or 300 according to one or more embodiments may include an operation 1650 or 1730 of driving the first sub-pixel 545 R1 based on the at least one piece of pixel data.

The operating method of the electronic device 101, 200, or 300 according to one or more embodiments may include an operation 1670, 1740, or 1780 of controlling the switching circuit 580, 581, or 583 to connect the first main gate line 571 Main Gate Line #0 to a second sub-pixel 555 R2 included in a second pixel 550 disposed in a second direction of the first pixel 540, or connect the first main source line 575 Main Source Line #0 to a third sub-pixel 565 R3 included in a third pixel 560 disposed in a first direction intersecting the second direction of the first pixel 540.

The operating method of the electronic device 101, 200, or 300 according to one or more embodiments may include an operation 1690, 1750, or 1790 of driving the second sub-pixel 555 R2 or the third sub-pixel 565 R3 based on the at least one piece of pixel data.

In the operating method of the electronic device 101, 200, or 300 according to one or more embodiments, through the operation 1610 or 1710 of obtaining the at least one piece of pixel data, first pixel data and second pixel data different from the first pixel data may be acquired.

In the operation 1650 or 1730 of driving the first sub-pixel 545 R1, the first sub-pixel 545 R1 may be driven based on the first pixel data. In the operation 1690, 1750, or 1790 of driving the second sub-pixel 555 R2 or the third sub-pixel 565 R3, the second sub-pixel 555 R2 or the third sub-pixel 565 R3 may be driven based on the second pixel data.

In the operating method of the electronic device 101, 200, or 300 according to one or more embodiments, the operation 1670, 1740, or 1780 of controlling the switching circuit 580, 581, or 583 to connect the first main gate line 571 Main Gate Line #0 to the second sub-pixel 555 R3 or connect the first main source line 575 Main Source Line #0 to the third sub-pixel 565 R3 may include an operation 1740 of controlling the first switching circuit 580, 581, or 583 configured to selectively connect the first main gate line 571 Main Gate Line #0 to the first sub-pixel 545 R1 or to the second sub-pixel 555 R2 so that the first main gate line 571 Main Gate Line #0 is connected to the second sub-pixel 555 R3.

In the operating method of the electronic device 101, 200, or 300 according to one or more embodiments, the operation 1670, 1740, or 1780 of controlling the switching circuit 580, 581, or 583 to connect the first main gate line 571 Main Gate Line #0 to the second sub-pixel 555 R3 or connect the first main source line 575 Main Source Line #0 to the third sub-pixel 565 R3 may include an operation 1780 of controlling the second switching circuit 580, 581, or 583 configured to selectively connect the first main source line 575 Main Source Line #0 to the first sub-pixel 545 R1 or to the third sub-pixel 565 R3 so that the first main source line 575 Main Source Line #0 is connected to the third sub-pixel 565 R3.

A non-transitory computer-readable storage medium according to one or more embodiments of the disclosure may include an operation 1610 or 1710 of obtaining at least one piece of pixel data corresponding to a first pixel 540 of a display panel 535, based on execution of an application.

The storage medium according to one or more embodiments may include an operation 1630 or 1720 of controlling a switching circuit 580, 581, or 583 to connect a first main gate line 571 Main Gate Line #0 configured to be electrically connectible to the first pixel 540 and a first main source line 575 Main Source Line #0 to a first sub-pixel 545 R1 included in the first pixel 540.

The storage medium according to one or more embodiments may include an operation 1650 or 1730 of driving the first sub-pixel 545 R1 based on the at least one piece of pixel data.

The storage medium according to one or more embodiments may include an operation 1670, 1740, or 1780 of controlling the switching circuit 580, 581, or 583 to connect the first main gate line 571 Main Gate Line #0 to a second sub-pixel 555 R2 included in a second pixel 550 disposed in a second direction of the first pixel 540, or connect the first main source line 575 Main Source Line #0 to a third sub-pixel 565 R3 included in a third pixel 560 disposed in a first direction intersecting the second direction of the first pixel 540.

The storage medium according to one or more embodiments may include an operation 1690, 1750, or 1790 of driving the second sub-pixel 555 R2 or the third sub-pixel 565 R3 based on the at least one piece of pixel data.

An electronic device 101, 200, or 300 according to one or more embodiments may include a display panel 535 in which a plurality of pixels 540, 550, 560, and 590 are arranged in a matrix form, and a first main gate line 571 Main Gate Line #0 extending in a first direction and configured to be electrically connectible to a first pixel 540 among the plurality of pixels 540, 550, 560, and 590 and a third pixel 560 disposed in the first direction of the first pixel 540.

The electronic device according to one or more embodiments may include a first main source line 575 Main Source Line #0 extending in a second direction intersecting the first direction and configured to be electrically connectible to the first pixel 540 and a second pixel 550 located in the second direction of the first pixel 540.

The electronic device according to one or more embodiments may include a first switching circuit 580, 581, or 583 connected to the first main gate line 571 Main Gate Line #0 and configured to selectively connect the first main gate line 571 Main Gate Line #0 to the first sub-pixel 545 R1 or a second sub-pixel 555 R2 included in the second pixel 550.

The electronic device according to one or more embodiments may include a second switching circuit 580, 581, or 583 connected to the first main source line 575 Main Source Line #0 and configured to selectively connect the first main source line 575 Main Source Line #0 to the first sub-pixel 545 R1 or a third sub-pixel 565 R3 included in the third pixel 560.

The electronic device according to one or more embodiments may include a display driving IC 537 or 430 electrically connected to the display panel 535 and configured to drive the display panel 535.

The display driving circuit 537 or 430 according to one or more embodiments may be configured to control the first switching circuit 580, 581, or 583 to sequentially connect the first main gate line 571 Main Gate Line #0 to the first sub-pixel 545 R1 and the second sub-pixel 555 R2 or control the second switching circuit 580, 581, or 583 to sequentially connect the first main source line 575 Main Source Line #0 to the first sub-pixel 545 R1 and the third sub-pixel 565 R3.

In the electronic device 101, 200, or 300 according to one or more embodiments, the display driving circuit 537 or 430 may be configured to control the first switching circuit 580, 581, or 583 or the second switching circuit 580, 581, or 583 to connect the first main gate line 571 Main Gate Line #0 and the first main source line 575 Main Source Line #0 to the first sub-pixel 545 R1.

The display driving circuit 537 or 430 according to one or more embodiments may be configured to drive the first sub-pixel 545 R1 based on the first pixel data.

The display driving circuit 537 or 430 according to one or more embodiments may be configured to drive the second sub-pixel 555 R2 or the third sub-pixel 565 R3 based on second pixel data different from the first pixel data, based on a control operation of the first switching circuit 580, 581, or 583 or the second switching circuit 580, 581, or 583.

In the electronic device 101, 200, or 300 according to one or more embodiments, a plurality of sub-pixels may be arranged in a matrix form along the first direction and the second direction in the first pixel 540, the second pixel 550, and the third pixel 560.

In the electronic device 101, 200, or 300 according to one or more embodiments, the first main gate line 571 Main Gate Line #0 may be always connected to a first common pixel of the first pixel 540 located between the first sub-pixel 545 R1 and the second sub-pixel 555 R2 and selectively connected to the first sub-pixel 545 R1 or the second sub-pixel 555 R2 through the first switching circuit 580, 581, or 583.

In the electronic device 101, 200, or 300 according to one or more embodiments, the first main source line 575 Main Source Line #0 may be always connected to a second common pixel of the first pixel 540 located between the first sub-pixel 545 R1 and the third sub-pixel 565 R3 and selectively connected to the first sub-pixel 545 R1 or the third sub-pixel 565 R3 through the second switching circuit 580, 581, or 583.

In the electronic device 101, 200, or 300 according to one or more embodiments, the first switching circuit 580, 581, or 583 may include a first switch 1010, 1020, or 1030 configured to selectively connect, to the first main gate line 571 Main Gate Line #0, a first sub-gate line Sub Gate Line #0 which is connected to the first sub-pixel 545 R1, the second common pixel, and the third sub-pixel 565 R3, or a third sub-gate line Sub Gate Line #2 which extends parallel to the first sub-gate line Sub Gate Line #0 and is connected to the second sub-pixel 555 R2.

In the electronic device 101, 200, or 300 according to one or more embodiments, the second switching circuit 580, 581, or 583 may include a second switch 1210, 1220, or 1230 configured to selectively connect, to the first main source line 575 Main Source Line #0, a first sub-source line Sub Source Line #0 which is connected to the first sub-pixel 545 R1, the first common pixel, and the second sub-pixel 555 R2, or a third sub-source line Sub Source Line #3 which extends parallel to the first sub-source line Sub Source Line #0 and is connected to the third sub-pixel 565 R3.

In the electronic device 101, 200, or 300 according to one or more embodiments, the display driving circuit 537 or 430 may be configured to control the first switch 1010, 1020, or 1030 and the second switch 1210, 1220, or 1230 to connect the first main gate line 571 Main Gate Line #0 to the first sub-gate line Sub Gate Line #0 and the first main source line 575 Main Source Line #0 to the first sub-source line Sub Source Line #0.

The display driving circuit 537 or 430 according to one or more embodiments may be configured to control the first switch 1010, 1020, or 1030 and the second switch 1210, 1220, or 1230 to connect the first main gate line 571 Main Gate Line #0 to the third sub-gate line Sub Gate Line #2 and the first main source line 575 Main Source Line #0 to the first sub-source line Sub Source Line #0.

The display driving circuit 537 or 430 according to one or more embodiments may be configured to control the first switch 1010, 1020, or 1030 and the second switch 1210, 1220, or 1230 to connect the first main gate line 571 Main Gate Line #0 to the third sub-gate line Sub Gate Line #2 and the first main source line 575 Main Source Line #0 to the third sub-source line Sub Source Line #2.

The display driving circuit 537 or 430 according to one or more embodiments may be configured to control the first switch 1010, 1020, or 1030 and the second switch 1210, 1220, or 1230 to connect the first main gate line 571 Main Gate Line #0 to the first sub-gate line Sub Gate Line #0 and the first main source line 575 Main Source Line #0 to the third sub-source line Sub Source Line #2.

A control method of an electronic device according to one or more embodiments of the disclosure may include an operation of obtaining at least one piece of pixel data corresponding to a first pixel of a display panel.

The operating method of the electronic device according to one or more embodiments may include an operation of controlling a first switching circuit to sequentially connect a first main gate line configured to be electrically connectible to the first pixel to the first sub-pixel included in the first pixel and the second sub-pixel included in the second pixel.

The operating method of the electronic device according to one or more embodiments may include an operation of driving the first sub-pixel or the second sub-pixel based on the at least one piece of pixel data.

The operating method of the electronic device according to one or more embodiments may include an operation of controlling a second switching circuit to sequentially connect a first main source line configured to be electrically connectible to the second pixel to the first sub-pixel included in the first pixel and the third sub-pixel included in the third pixel.

The operating method of the electronic device according to one or more embodiments may include an operation of driving the first sub-pixel or the third sub-pixel based on the at least one piece of pixel data.

A non-transitory computer-readable storage medium according to one or more embodiments of the disclosure may include an operation of obtaining at least one piece of pixel data corresponding to a first pixel of a display panel based on execution of an application.

The storage medium according to one or more embodiments may include an operation of controlling a first switching circuit to sequentially connect a first main gate line configured to be electrically connectible to the first pixel to the first sub-pixel included in the first pixel and the second sub-pixel included in the second pixel.

The storage medium according to one or more embodiments may include an operation of driving the first sub-pixel or the second sub-pixel based on the at least one piece of pixel data.

The storage medium according to one or more embodiments may include an operation of controlling a second switching circuit to sequentially connect a first main source line configured to be electrically connectible to the second pixel to the first sub-pixel included in the first pixel and the third sub-pixel included in the third pixel.

The storage medium according to one or more embodiments may include an operation of driving the second sub-pixel or the third sub-pixel based on the at least one piece of pixel data.

The electronic device according to an embodiment may be one of various types of electronic devices. The electronic devices may include, for example, a portable communication device (e.g., a smartphone), a computer device, a portable multimedia device, a portable medical device, a camera, an electronic device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display panel comprising a plurality of pixels arranged in a matrix;
a first main gate line extending in a first direction and configured to be electrically connectible to a first pixel among the plurality of pixels;
a second main gate line extending in the first direction and configured to be electrically connectible to a second pixel among the plurality of pixels, the second pixel being adjacent to the first pixel along a second direction intersecting the first direction;
a first main source line extending in the second direction and configured to be electrically connectible to the first pixel;
a second main source line extending in the second direction and configured to be electrically connectible to a third pixel among the plurality of pixels, the third pixel being adjacent to the first pixel in the first direction;
a switching circuit connected to one of the first main gate line or the first main source line and configured to selectively connect the first main gate line to a first sub-pixel included in the first pixel or a second sub-pixel included in the second pixel, or to selectively connect the first main source line to the first sub-pixel or a third sub-pixel in the third pixel; and
a display driving circuit electrically connected to the display panel and configured to drive the display panel.

2. The electronic device of claim 1, further comprising:
a first transistor array electrically connected to the first main gate line and the first main source line and configured to drive the first sub-pixel,
wherein the switching circuit is connected between the first transistor array and the first main gate line or the first main source line.

3. The electronic device of claim 1,
wherein a plurality of sub-pixels comprising the first sub-pixel are arranged in the first direction or the second direction in the first pixel, and
wherein the switching circuit comprises at least one switch corresponding to at least part of the plurality of sub-pixels.

4. The electronic device of claim 1, further comprising:
a lens in front of the display panel,
wherein the first pixel is at an edge area of the display panel.

5. The electronic device of claim 1, wherein the display driving circuit is further configured to:
control the switching circuit to connect the first main gate line and the first main source line to the first sub-pixel;
drive the first sub-pixel based on first pixel data;
control the switching circuit to connect the first main gate line to the second sub-pixel or to connect the first main source line to the third sub-pixel; and
drive the second sub-pixel or the third sub-pixel based on second pixel data different from the first pixel data.

6. The electronic device of claim 1,
wherein a first plurality of sub-pixels comprising the first sub-pixel are arranged in the second direction in the first pixel,
wherein a second plurality of sub-pixels comprising the second sub-pixel are arranged along the second direction in the second pixel,
wherein the second sub-pixel is adjacent to the first pixel along the second direction, and
wherein the switching circuit comprises a first switching circuit connected to the first main gate line, the first switching circuit being configured to selectively connect the first main gate line to the first sub-pixel or the second sub-pixel.

7. The electronic device of claim 6,
wherein the first switching circuit comprises a first switch configured to selectively connect a first sub-gate line or a third sub-gate line to the first main gate line,
wherein the first sub-gate line connects the first main gate line to the first sub-pixel, and the third sub-gate line connects the first main gate line to the second sub-pixel, and
wherein the display driving circuit is further configured to control the first switch to connect the first main gate line to the first sub-pixel and then connect the first main gate line to the second sub-pixel.

8. The electronic device of claim 1,
wherein a first plurality of sub-pixels comprising the first sub-pixel are arranged in the first direction in the first pixel,
wherein a second plurality of sub-pixels comprising the third sub-pixel are arranged in the first direction in the third pixel,
wherein the third sub-pixel is adjacent to the first pixel along the first direction, and
wherein the switching circuit comprises a second switching circuit connected to the first main source line, the second switching circuit being further configured to selectively connect the first main source line to the first sub-pixel or the third sub-pixel.

9. The electronic device of claim 8,
wherein the second switching circuit comprises a second switch configured to selectively connect a first sub-source line or a third sub-source line, to the first main source line,
wherein the first sub-source line connects the first main source line to the first sub-pixel and the third sub-source line connects the first main source line to the third sub-pixel, and
wherein the display driving circuit is further configured to control the second switch to connect the first main source line to the first sub-pixel and then connect the first main source line to the third sub-pixel.

10. The electronic device of claim 1,
wherein a plurality of sub-pixels are arranged in a matrix along the first direction and the second direction in the first pixel, the second pixel, and the third pixel,
wherein the second sub-pixel is adjacent to the first pixel along the second direction,
wherein the third sub-pixel is adjacent to the first pixel along the first direction, and
wherein the switching circuit comprises:
a first switching circuit connected to the first main gate line, the first switching circuit being configured to selectively connect the first main gate line to the first sub-pixel or the second sub-pixel; and
a second switching circuit connected to the first main source line, the second switching circuit being configured to selectively connect the first main source line to the first sub-pixel or the third sub-pixel.

11. The electronic device of claim 10, wherein the display driving circuit is further configured to:
control the switching circuit to connect the first main gate line and the first main source line to the first sub-pixel;
drive the first sub-pixel based on first pixel data;
control the first switching circuit to connect the first main gate line to the second sub-pixel;
drive the second sub-pixel based on second pixel data different from the first pixel data;
control the second switching circuit to connect the first main source line to the third sub-pixel; and
drive the third sub-pixel based on third pixel data different from the first pixel data and the second pixel data.

12. A method of operating an electronic device, the method comprising:
obtaining at least one piece of pixel data corresponding to a first pixel of a display panel;
controlling a switching circuit to connect a first main source line and a first main gate line configured to be electrically connectible to the first pixel, to a first sub-pixel included in the first pixel;
driving the first sub-pixel based on the at least one piece of pixel data;
controlling the switching circuit to connect the first main gate line to a second sub-pixel included in a second pixel adjacent to the first pixel in a second direction, or connect the first main source line to a third sub-pixel in a third pixel adjacent to the first pixel in a first direction intersecting the second direction; and
driving the second sub-pixel or the third sub-pixel based on the at least one piece of pixel data.

13. The method of claim 12,
wherein the obtaining the at least one piece of pixel data comprises obtaining first pixel data and second pixel data different from the first pixel data,
wherein the driving the first sub-pixel comprises driving the first sub-pixel based on the first pixel data, and
wherein the driving the second sub-pixel or the third sub-pixel comprises driving the second sub-pixel or the third sub-pixel based on the second pixel data.

14. The method of claim 12,
wherein the controlling the switching circuit to connect the first main gate line to the second sub-pixel or connect the first main source line to the third sub-pixel comprises controlling a first switching circuit to connect the first main gate line to the second sub-pixel, and
wherein the first switching circuit is configured to selectively connect the first main gate line to the first sub-pixel or the second sub-pixel.

15. The method of claim 12,
wherein the controlling the switching circuit to connect the first main gate line to the second sub-pixel or connect the first main source line to the third sub-pixel comprises controlling a second switching circuit to connect the first main source line to the third sub-pixel, and
wherein the second switching circuit is configured to selectively connect the first main source line to the first sub-pixel or the third sub-pixel.

16. An electronic device comprising:
a display panel comprising a plurality of pixels arranged in a matrix;
a first main gate line extending in a first direction and configured to be electrically connectible to a first pixel and a third pixel adjacent to the first pixel in the first direction among the plurality of pixels;
a first main source line extending in a second direction intersecting the first direction and configured to be electrically connectible to the first pixel and a second pixel adjacent to the first pixel in the second direction;
a first switching circuit connected to the first main gate line, the first switching circuit being configured to selectively connect the first main gate line to a first sub-pixel included in the first pixel or a second sub-pixel included in the second pixel;
a second switching circuit connected to the first main source line, the second switching circuit being configured to selectively connect the first main source line to the first sub-pixel or a third sub-pixel in the third pixel; and
a display driving circuit electrically connected to the display panel and configured to drive the display panel,
wherein the display driving circuit is configured to control the first switching circuit to sequentially connect the first main gate line to the first sub-pixel and the second sub-pixel, or to control the second switching circuit to sequentially connect the first main source line to the first sub-pixel and the third sub-pixel.

17. The electronic device of claim 16, wherein the display driving circuit is further configured to:
control the first switching circuit or the second switching circuit to connect the first main gate line and the first main source line to the first sub-pixel;
drive the first sub-pixel based on first pixel data; and
drive the second sub-pixel or the third sub-pixel based on second pixel data different from the first pixel data, based on a control operation of the first switching circuit or the second switching circuit.

18. The electronic device of claim 16,
wherein a plurality of sub-pixels are arranged in a matrix along the first direction and the second direction in the first pixel, the second pixel, and the third pixel,
wherein the first main gate line is always connected to a first common pixel of the first pixel between the first sub-pixel and the second sub-pixel, and selectively connected to the first sub-pixel or the second sub-pixel through the first switching circuit, and
wherein the first main source line is always connected to a second common pixel of the first pixel between the first sub-pixel and the third sub-pixel, and selectively connected to the first sub-pixel or the third sub-pixel through the second switching circuit.

19. The electronic device of claim 18,
wherein the first switching circuit comprises a first switch configured to selectively connect a first sub-gate line or a third sub-gate line, to the first main gate line,
wherein the first sub-gate line is connected to the first sub-pixel, the second common pixel, and the third sub-pixel,
wherein the third sub-gate line extends parallel to the first sub-gate line and is connected to the second sub-pixel,
wherein the second switching circuit comprises a second switch configured to selectively connect a first sub-source line or a third sub-source line, to the first main source line,
wherein the first sub-source line is connected to the first sub-pixel, the first common pixel, and the second sub-pixel, and
wherein the third sub-source line extends parallel to the first sub-source line and is connected to the third sub-pixel.

20. The electronic device of claim 19, wherein the display driving circuit is further configured to:
control the first switch and the second switch to connect the first main gate line to the first sub-gate line and the first main source line to the first sub-source line;
control the first switch and the second switch to connect the first main gate line to the third sub-gate line and the first main source line to the first sub-source line;
control the first switch and the second switch to connect the first main gate line to the third sub-gate line and the first main source line to the third sub-source line; and
control the first switch and the second switch to connect the first main gate line to the first sub-gate line and the first main source line to the third sub-source line.
